(19) United States
(12) Patent Application Publication
(10) Pub. No.: US 2017/0098911 A1
(43) Pub. Date: Apr. 6, 2017

(54) Method for Reducing Crosstalk in Electrical Connectors

(71) Applicant: Panduit Corp., Tinley Park, IL (US)

(72) Inventors: Jack E. Caveney, North Palm Beach, FL (US); Masud Bolouri-Saransar, Orland Park, IL (US); Scott M. Lesniak, New Lenox, IL (US); Satish I. Patel, Roselle, IL (US); Paul W. Wachtel, Arlington Heights, IL (US)

(73) Assignee: Panduit Corp., Tinley Park, IL (US)

(21) Appl. No.: 15/288,259

(22) Filed: Dec. 21, 2016

Related U.S. Application Data
(63) Continuation-in-part of application No. 15/220,789, filed on Jul. 27, 2016.
Application No. 15/220,789 is a continuation of application No. 14/474,479, filed on Sep. 2, 2014, now Pat. No. 9,407,044.
Application No. 14/474,479 is a continuation of application No. 12/916,687, filed on Nov. 1, 2010, now Pat. No. 8,826,532.
Application No. 12/916,687 is a continuation of application No. 11/833,686, filed on Aug. 3, 2007, now Pat. No. 7,823,281.
Application No. 11/833,686 is a continuation of application No. 11/078,816, filed on Mar. 11, 2005, now Pat. No. 7,252,554.
(60) Provisional application No. 60/552,995, filed on Mar. 12, 2004.
(60) Provisional application No. 60/558,657, filed on Apr. 1, 2004.

(51) Int. Cl. H01R 13/6461; H01R 24/64

(52) U.S. Cl. CPC H01R 13/6461; H01R 24/64; H01R 2107/00

(57) ABSTRACT

An apparatus and method for crosstalk compensation in a jack of a modular communications connector includes connected to the plug interface contacts proximate the plug/jack interface. The structure configured to allow the current to flow generally orthogonal to the plug interface contact.

### CROSS-REFERENCE TO RELATED APPLICATIONS

This application is a continuation-in-part of U.S. patent application Ser. No. 15/220,789, filed Jul. 27, 2016, which is a continuation of U.S. patent application Ser. No. 14/474,479, filed Sep. 2, 2014, which issued as U.S. Pat. No. 9,407,044 on Aug. 2, 2016; which is a continuation of U.S. patent application Ser. No. 12/916,687, which was filed on Nov. 1, 2010, which issued as U.S. Pat. No. 8,826,532 on Sep. 9, 2014; which is a continuation of U.S. patent application Ser. No. 11/833,686, filed Aug. 3, 2007, which issued as U.S. Pat. No. 7,823,281 on Nov. 2, 2010; which is a continuation of U.S. patent application Ser. No. 11/078,816, filed Mar. 11, 2005, which issued as U.S. Pat. No. 7,252,554 on Aug. 7, 2007; which claims the benefit of U.S. Provisional Application Ser. No. 60/558,657, filed Apr. 1, 2004; and U.S. Provisional Application Ser. No. 60/552,995, filed Mar. 12, 2004, which are incorporated herein by reference in their entireties.

### TECHNICAL FIELD

The present invention relates to electrical connectors and more particularly relates to modular communication connectors that utilize compensation techniques to reduce net crosstalk generated by the combination of a plug and a jack of a connector assembly.

### BACKGROUND

Computer networks, including local area networks (LANs) and wide area networks (WANs), are becoming increasingly prevalent as the number of computers and network devices in the workplace grows. These computer networks utilize data communication cables and electrical connectors to transmit information between various components attached to the network. The electrical connectors are typically configured to include a plug that is connectable to a jack mounted in the wall, or integrated into a panel or other telecommunication equipment. The jack typically includes a housing that holds an array of closely spaced parallel contacts for contacting corresponding conductors of the plug. The contacts of a jack are often mounted onto a printed circuit board. An RJ45 plug and jack connector assembly is one well-known standard connector assembly having closely spaced contacts.

Over the past several years, advances in computer networking technology have facilitated a corresponding increase in the rate at which data can be transmitted through a network. Conventional connectors have been used to transmit low-frequency data signals without any significant crosstalk problems. However, when such connectors are used to transmit high-frequency data signals, crosstalk generated within the connector increases dramatically. This crosstalk is primarily due to the capacitive and inductive couplings between the closely spaced parallel conductors within the jack and/or the plug.

A wide variety of improvements have been made in the design of electrical connectors to reduce crosstalk occurring within connectors. One example is disclosed in U.S. Pat. No. 6,305,950, which is commonly assigned to Panduit Corporation. This type of connector uses a particular conductor configuration in conjunction with a multi-layered printed circuit board containing capacitors to achieve a reduction in the crosstalk effect. However, due to the high level of crosstalk occurring in the plug for this connector at very high-frequency signal rates, the tuning effect achievable by the capacitors can still be difficult to accomplish. As such, further improvements in the design of connectors are still needed to address such problems and provide improved crosstalk performance.

### SUMMARY OF THE INVENTION

According to one embodiment of the present invention, a communications connector utilizes a flexible printed circuit to provide crosstalk compensation. The flexible printed circuit is in electrical contact with contacts of the communications connector.

### BRIEF DESCRIPTION OF FIGURES

FIG. 1 is an exploded view of an electrical jack according to one embodiment of the present invention;

FIG. 2 is an exploded view of a contact assembly showing the use of a flexible printed circuit;

FIG. 3 is a rear perspective view of the contact assembly of FIG. 2;

FIG. 4 is a side cutaway view of the electrical jack of FIG. 1;

FIG. 5 is a side cutaway view of an electrical jack according to an alternative embodiment of the present invention;

FIG. 6 is a plan view of a flexible printed circuit showing zones A-F;

FIG. 6A is a detail view of Zone A of the flexible printed circuit of FIG. 6;

FIG. 6B is a detail view of Zone B of the flexible printed circuit of FIG. 6;

FIG. 6C is a detail view of Zone C of the flexible printed circuit of FIG. 6;

FIG. 6D is a detail view of Zone D of the flexible printed circuit of FIG. 6;

FIG. 6E is a detail view of Zone E of the flexible printed circuit of FIG. 6;

FIG. 6F is a detail view of Zone F of the flexible printed circuit of FIG. 6;

FIG. 6G is a plan view of the flexible printed circuit of FIG. 6, with sectional lines;

FIG. 6H is a plan view of the flexible printed circuit of FIG. 6 showing a conductive trace associated with a first conductor;

FIG. 6I is a plan view of the flexible printed circuit of FIG. 6 showing a conductive trace associated with a second conductor;

FIG. 6J is a plan view of the flexible printed circuit of FIG. 6 showing a conductive trace associated with a third conductor;

FIG. 6K is a plan view of the flexible printed circuit of FIG. 6 showing a conductive trace associated with a fourth conductor;

FIG. 6L is a plan view of the flexible printed circuit of FIG. 6 showing a conductive trace associated with a fifth conductor;

FIG. 6M is a plan view of the flexible printed circuit of FIG. 6 showing a conductive trace associated with a sixth conductor;

FIG. 6N is a plan view of the flexible printed circuit of FIG. 6 showing a conductive trace associated with a seventh conductor;

FIG. 6O is a plan view of the flexible printed circuit of FIG. 6 showing a conductive trace associated with an eighth conductor;

FIG. 7 is a sectional view of the flexible printed circuit of FIG. 6 taken along the line A-A of FIG. 6g;

FIG. 8A is a sectional view of the flexible printed circuit of FIG. 6 taken along the line B-B of FIG. 6G;

FIG. 8B is a sectional view of the flexible printed circuit of FIG. 6 taken along the line C-C of FIG. 6G;

FIG. 9 is a sectional view of the flexible printed circuit of FIG. 6 taken along the line D-D of FIG. 6G;

FIG. 10A is a sectional view of the flexible printed circuit of FIG. 6 taken along the line E-E of FIG. 6G;

FIG. 10B is a sectional view of the flexible printed circuit of FIG. 6 taken along the line F-F of FIG. 6G;

FIG. 11 is a sectional view of the flexible printed circuit of FIG. 6 taken along the line G-G of FIG. 6G;

FIG. 12 is a sectional view of the flexible printed circuit of FIG. 6 taken along the line H-H of FIG. 6G;

FIG. 13 is a sectional view of the flexible printed circuit of FIG. 6 taken along the line I-I of FIG. 6G;

FIG. 14 is a detail view of the detail J of FIG. 6G;

FIG. 15 is a detail view of the detail K of FIG. 6G;

FIG. 16 is a detail view of the detail L of FIG. 6G;

FIG. 17 is a detail view of the detail M of FIG. 6G;

FIG. 18 is a side cutaway view of an electrical jack according to another alternative embodiment of the present invention;

FIG. 19 is an exploded view of the electrical jack of FIG. 18;

FIG. 20 is a detail view of the detail N of FIG. 19;

FIG. 21 is a perspective view of a contact-and-housing assembly of the electrical jack of FIG. 18;

FIG. 21A is a perspective view of an alternate embodiment of a contact-and-housing assembly of the electrical jack of FIG. 18;

FIG. 22 is a perspective view of the contact-and-housing assembly of the electrical jack of FIG. 18;

FIG. 23 is a perspective view of IDCs and associated stems according to one embodiment of the present invention;

FIG. 24 is a top view of IDCs of FIG. 23;

FIG. 25 is a front view of the IDCs of FIG. 23;

FIG. 26 is a rear view of the IDCs of FIG. 23;

FIG. 27 is a side view of the IDCs of FIG. 23;

FIG. 28 is a detail view of the detail O of FIG. 27;

FIG. 29 is a detail view of the detail P of FIG. 27;

FIG. 30 is a sectional view taken along the line Q-Q of FIG. 27;

FIG. 31 is a plan view of an alternative FPC 200, which may be used with the jack shown in FIGS. 33-45;

FIG. 32 is a perspective view of the variable capacitance 250 shown in FIG. 31;

FIG. 33 is a side cutaway view of the front portion of a jack, showing contact 1 or 8 in a combed position;

FIG. 34 is a side cutaway view of the front portion of a jack, showing contact 1 or 8 in a solid-plug position;

FIG. 35 is a side cutaway view of the front portion of a jack, showing contacts 2, 4, 5, or 7 in a combed position;

FIG. 36 is an upper right-hand front exploded perspective view of a jack in accordance with an embodiment of the present invention;

FIG. 37 is a close-up view showing detail of the front sled with contacts, including spring contacts;

FIG. 38 is a close-up view showing detail of the rear contact guides;

FIG. 39 is a lower left-hand rear exploded perspective view of a jack in accordance with an embodiment of the present invention;

FIG. 40 is a close-up view showing detail of the bottom of the front sled with contacts, including spring contacts;

FIG. 41 is a first rear perspective view of the housing of a jack in accordance with an embodiment of the present invention;

FIG. 42 is a second rear perspective view of the housing of a jack in accordance with an embodiment of the present invention;

FIG. 43 is a perspective view of the contacts, including spring contacts;

FIG. 44 is a perspective view of a long contact; and

FIG. 45 is a perspective view of a short contact.

FIG. 46 is an isometric view of a communication system showing a patch panel capable of using high speed RJ45 jacks of the present invention.

FIG. 47 is an isometric view of second embodiment of a high speed RJ45 jack of the present invention mated with a plug.

FIG. 48 is an exploded isometric view of the RJ45 jack of FIG. 47.

FIG. 49 is a rotated isometric view of a front sled assembly to be used in the high speed connector of FIG. 47.

FIG. 50 is an exploded isometric view of the front sled assembly of FIG. 49.

FIG. 51 is a cross-sectional view of the mated plug and jack of FIG. 47 taken along line 51-51.

FIG. 52 is an isometric view of the front sled assembly of FIG. 49 (with the sled being shown as a dashed outline) highlighting the signal paths of the 3-6 split pair.

FIG. 53 is an isometric view from the bottom of the front sled assembly of FIG. 52.

FIG. 54 is a side view of the front sled assembly of FIG. 52.

FIG. 55 is an isometric view of a contact assembly of a first alternate sled assembly for the high speed RJ45 jack of FIG. 47.

FIG. 56 is a side view of the contact assembly of FIG. 55.

FIG. 57 is an isometric view of a second alternate sled assembly for the high speed RJ45 jack of FIG. 47.

FIG. 58 is the 3-6 split pair contact assembly for the front sled assembly of FIG. 57 including PICs, PIC cover and flexible PCB.

FIG. 59 is an exploded isometric view of the 3-6 split pair PIC assembly of FIG. 13.

FIG. 60 is an isometric view of a flexible PCB for use with the split-pair PIC assembly of FIG. 59.

FIG. 61 is an isometric view of a high speed RJ45 jack with a third alternate front sled assembly.

FIG. 62 is an isometric view of the third alternate sled assembly for the jack of FIG. 6I.

FIG. 63 is an isometric view from the bottom of the front sled assembly of FIG. 62.

### DETAILED DESCRIPTION OF PREFERRED EMBODIMENTS

The present invention is directed to methods and apparatus for reducing crosstalk in electrical connectors. The present invention utilizes crosstalk-reduction principles of U.S. Pat. No. 5,997,358 to Adriaenssens et al., which is incorporated herein by reference in its entirety. The present application further incorporates by reference in its entirety commonly-assigned U.S. Provisional Patent Application No. 60/544,050 entitled “Methods and Apparatus for Reducing Crosstalk in Electrical Connectors,” filed Feb. 12, 2004, and commonly-assigned U.S. patent application Ser. No. 11/055,344, entitled “Methods and Apparatus for Reducing Crosstalk in Electrical Connectors,” filed Feb. 10, 2005.

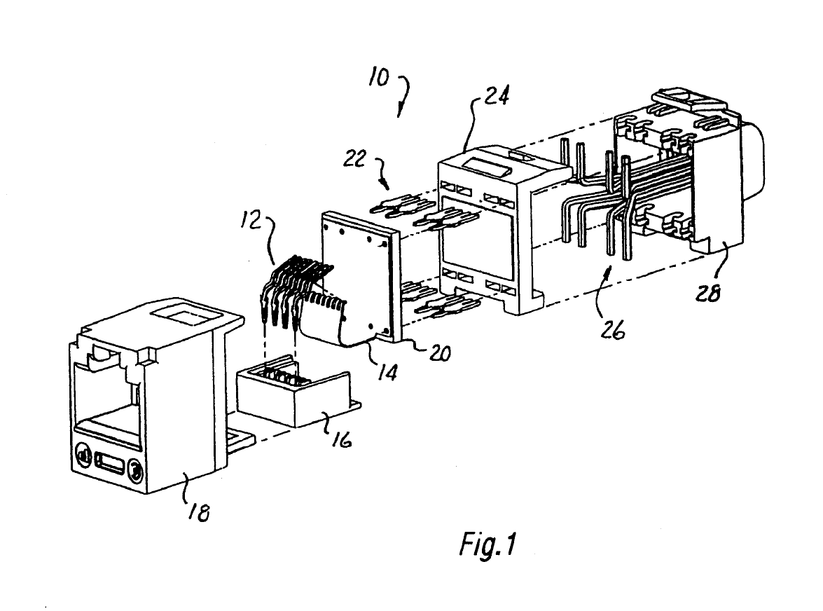

Turning now to FIG. 1, an exploded view of an electrical jack 10 is shown. Contacts 12 are adapted to make physical and electrical contact with contacts of a plug (not shown in FIG. 1) and further to make electrical contact with a flexible printed circuit (FPC) 14. The contacts 12 are mechanically mounted in a contact sled 16 and the contact-and-sled assembly is adapted for insertion into a main jack housing 18.

In the embodiment shown in FIG. 1, the FPC 14 has a rigid extension 20 adapted for accepting insulation displacement connectors (IDCs) 22. According to one embodiment of the present invention, the rigid extension 20 is an integral end portion of the FPC. The IDCs 22 extend through a rear housing 24 and make physical and electrical contact with conductors 26. In the embodiment of FIG. 1, eight conductors 26 are provided in four pairs. A termination cap 28 encloses the connections between the IDCs 22 and the conductors 26. Other styles of terminations, such as punch-down style terminations, may also be used with the present invention.

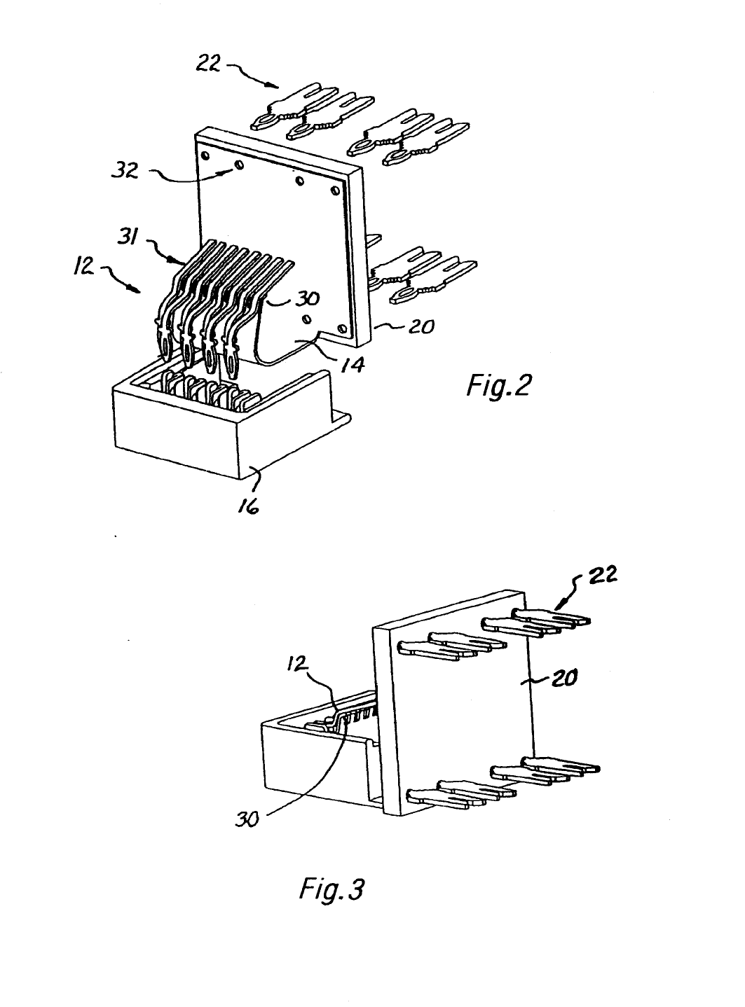

Turning now to FIG. 2, an exploded view of a contact assembly shows the connection between the contacts 12 and the FPC 14 at jack contact points 30 of the FPC 14. The mechanical and electrical connection between the FPC 14 and the contacts 12 is directly under the plug/jack interface 31. The jack contact points 30 of the FPC 14 are preferably attached to the contacts 12 opposite a plug/jack interface by electrical resistance welding of solder rivets. The jack contacts 12 are relatively short and they do not conduct signal current down their length. The IDCs 22 extend through the rigid extension 20 of the FPC 14 into IDC sockets 32 of the FPC 14. FIG. 3 is a back perspective view of the contact assembly of FIG. 2 showing the jack contact points 30 of the FPC contacting the contacts 12 and further showing the IDCs 22 extending from the rigid extension 20 of the FPC 14.

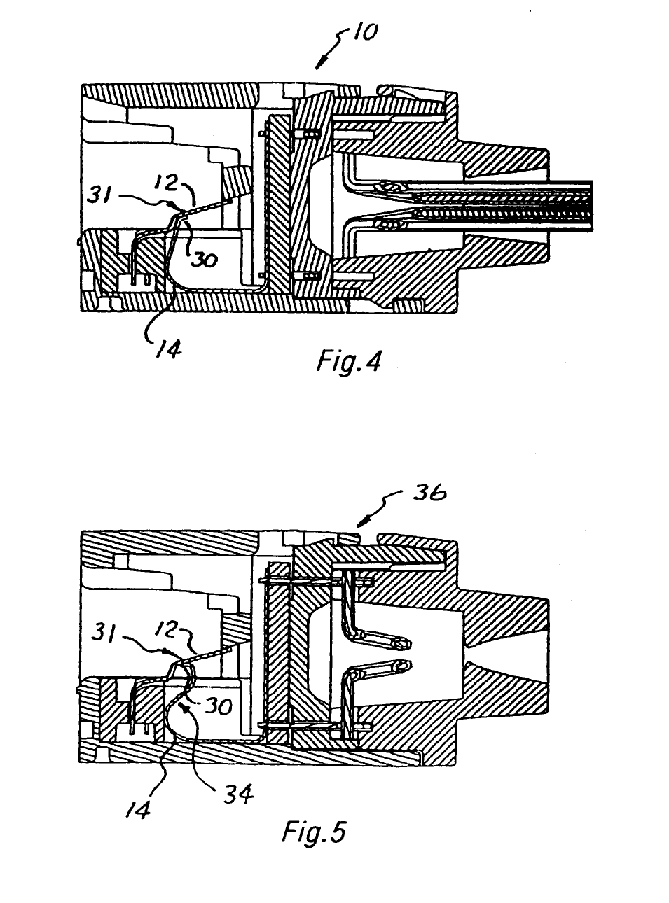

FPCs according to the present invention may be positioned in a variety of ways. For example, FIGS. 4 and 5 are side cutaway views showing two configurations of an FPC 14 in electrical jacks. In FIG. 4, the FPC 14 is placed such that the jack contact points 30 of the FPC 14 bend toward the rear of the electrical jack 10. This is the configuration shown in FIG. 1. FIG. 5 shows an alternative configuration in which a forward bend 34 is provided in the FPC 14 such that the jack contact points 30 bend toward the front of the alternative electrical jack 36. In FIGS. 4 and 5, the jack contact points 30 of the FPC 14 contact the contacts 12 of the jacks directly under the plug/jack interface 31.

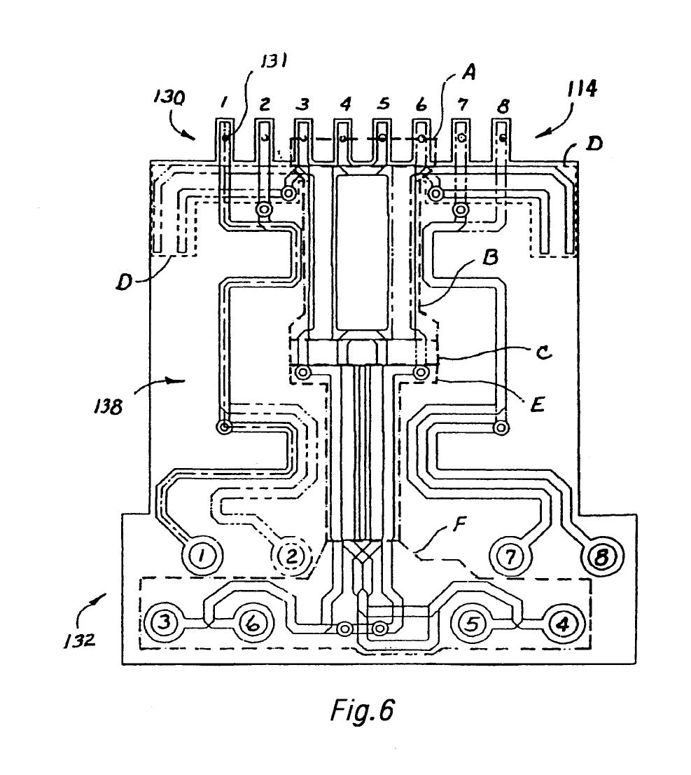

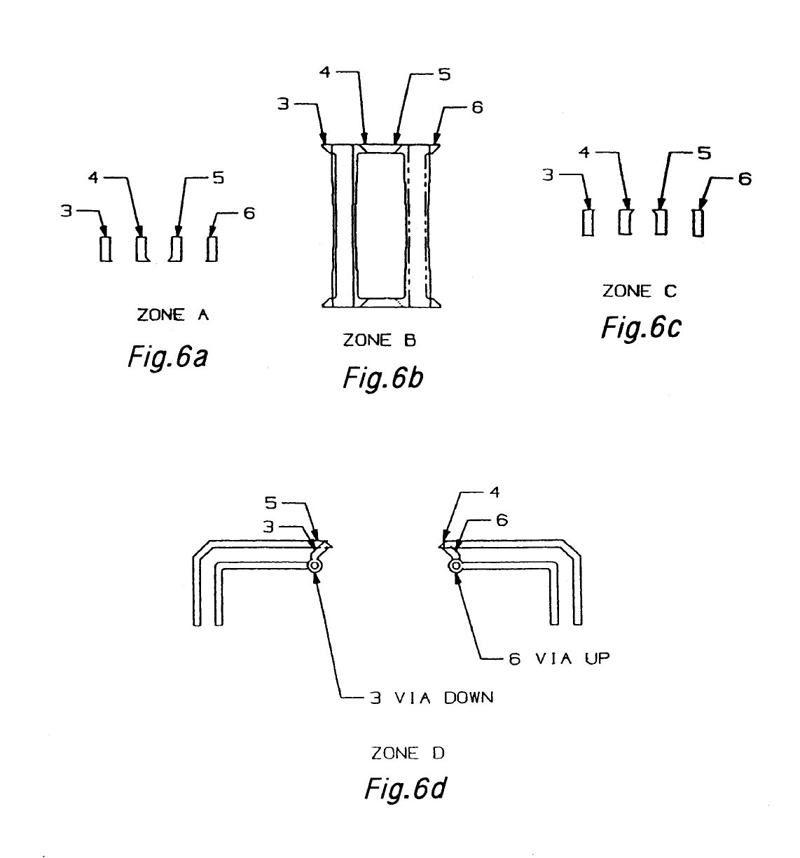

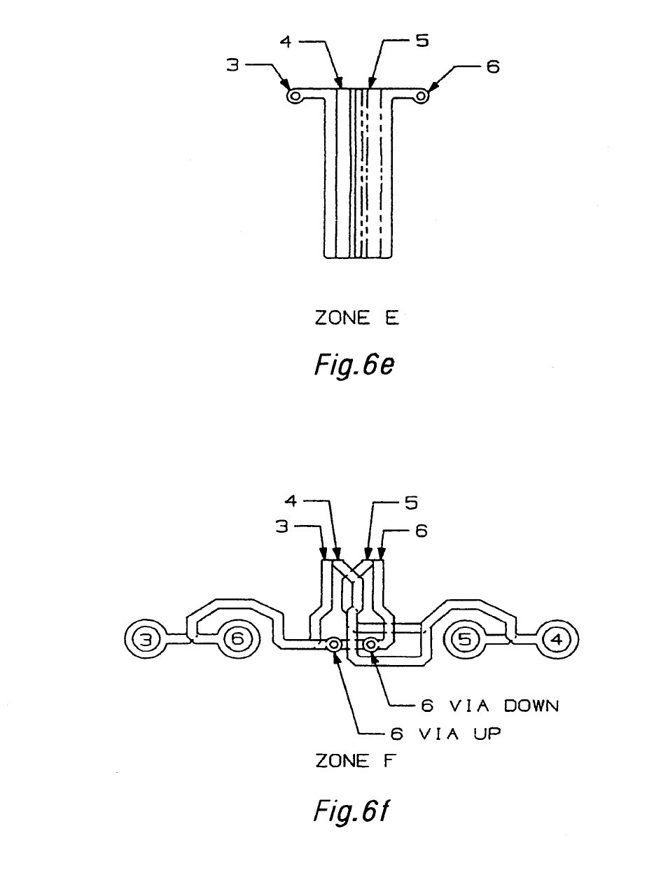

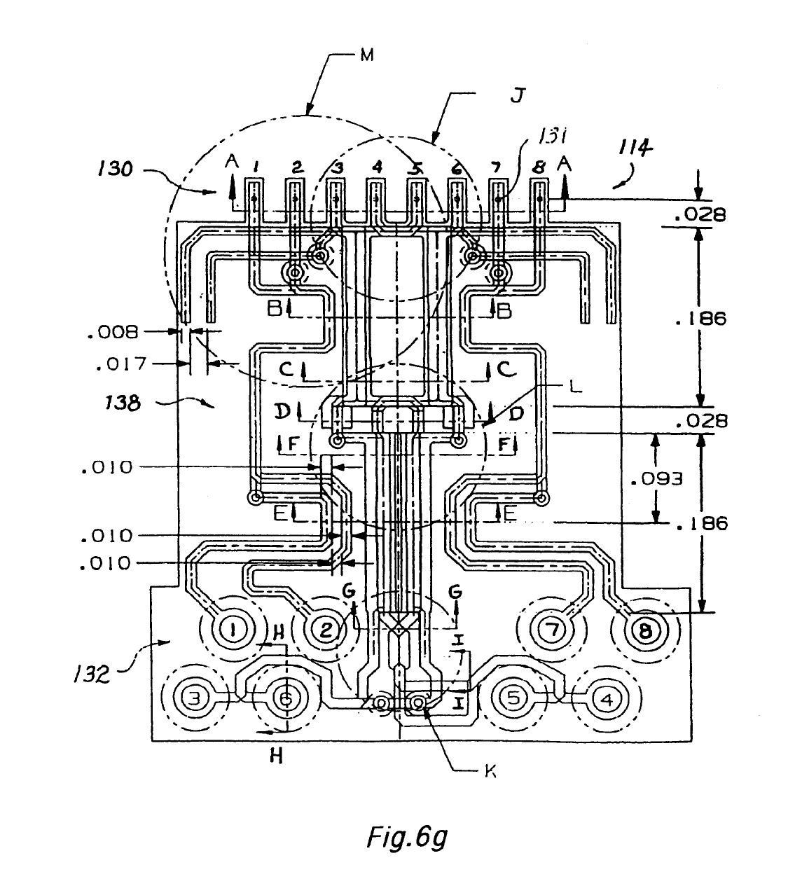

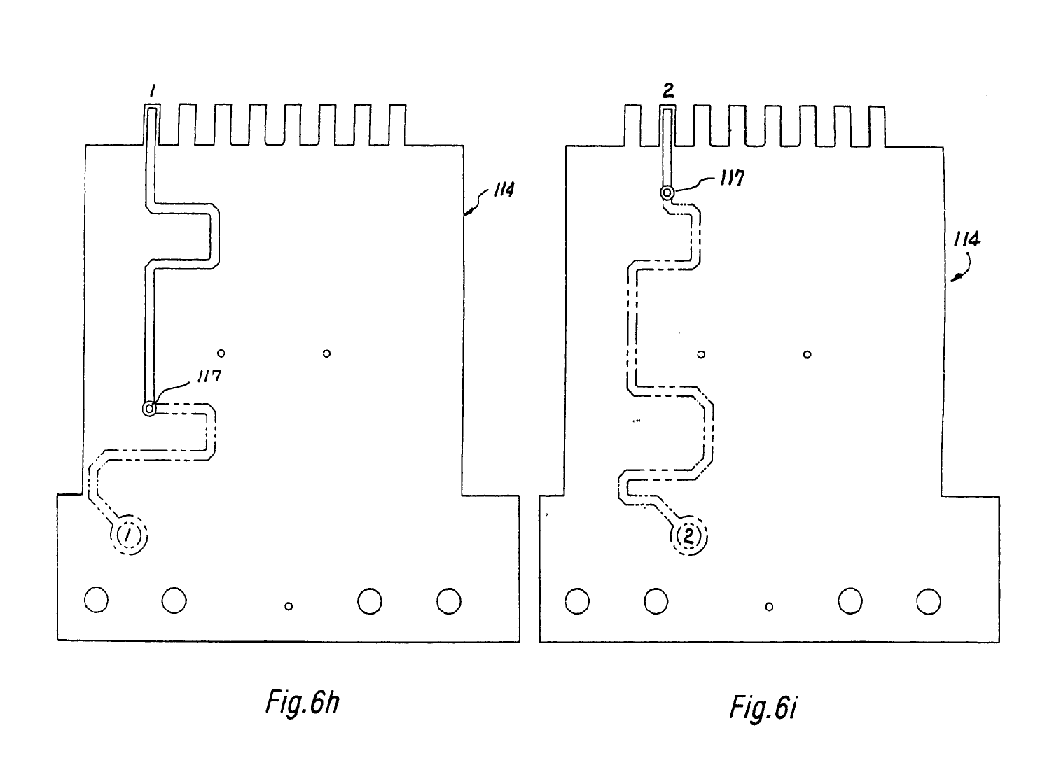

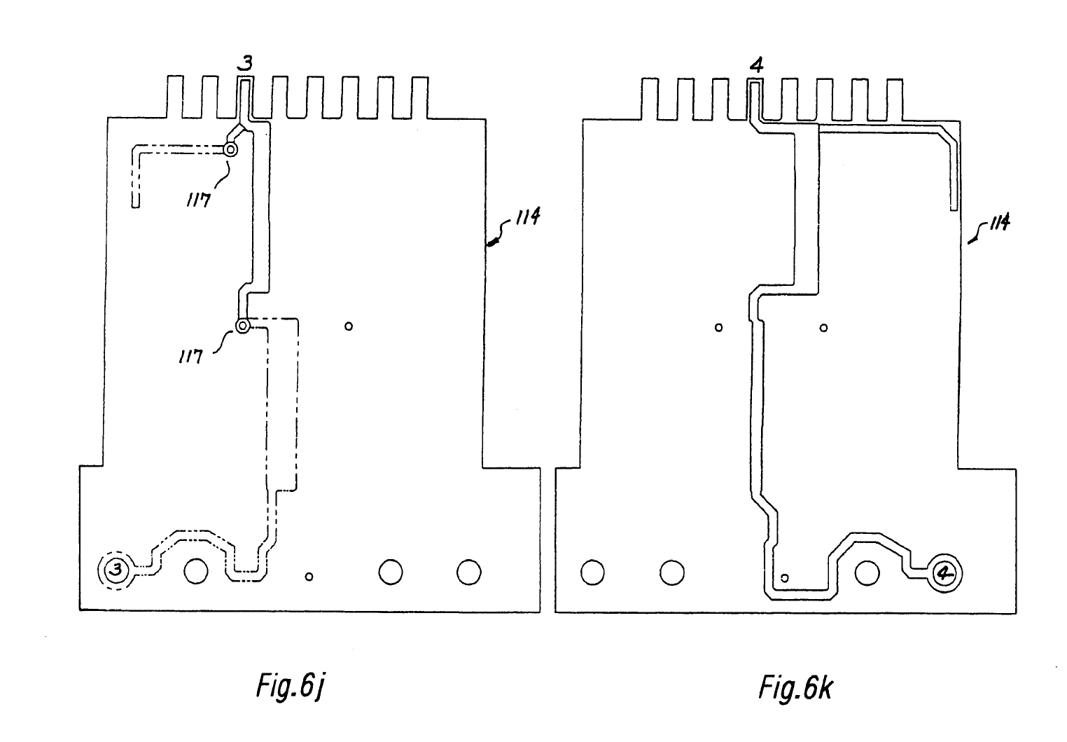

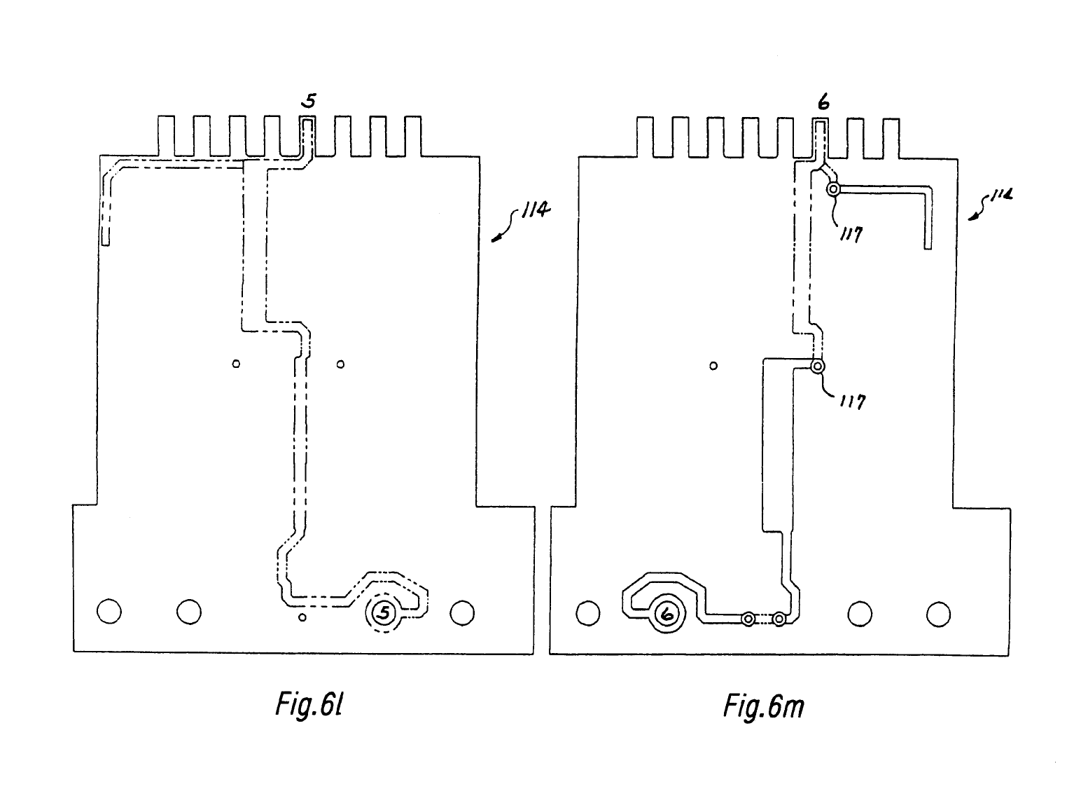

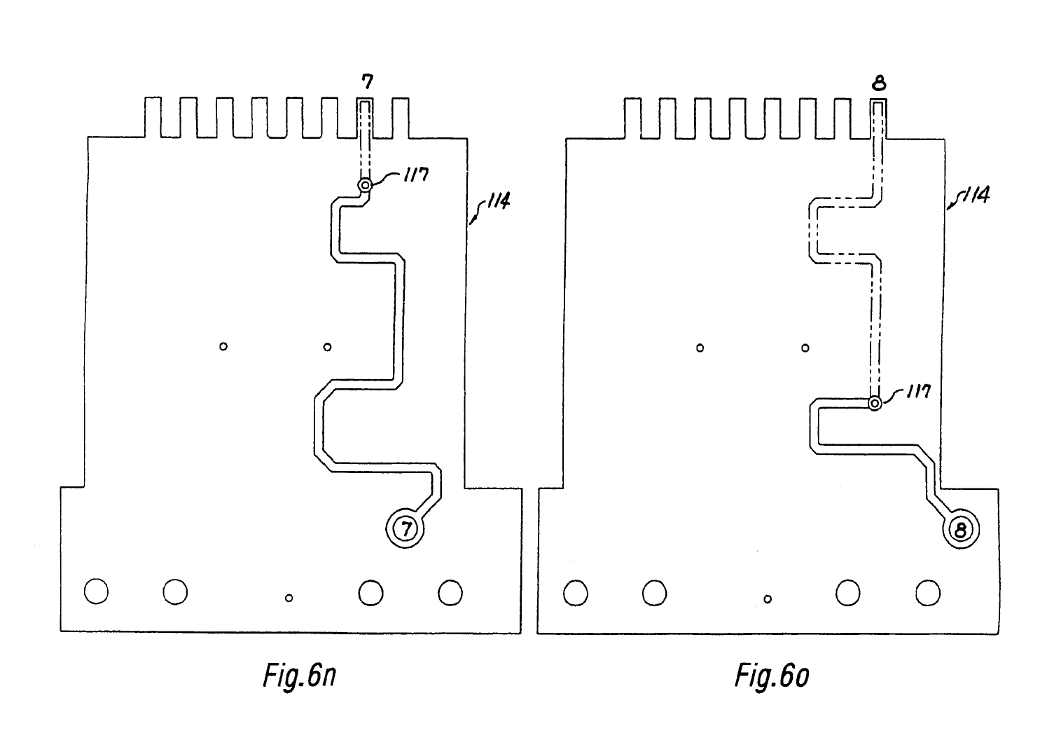

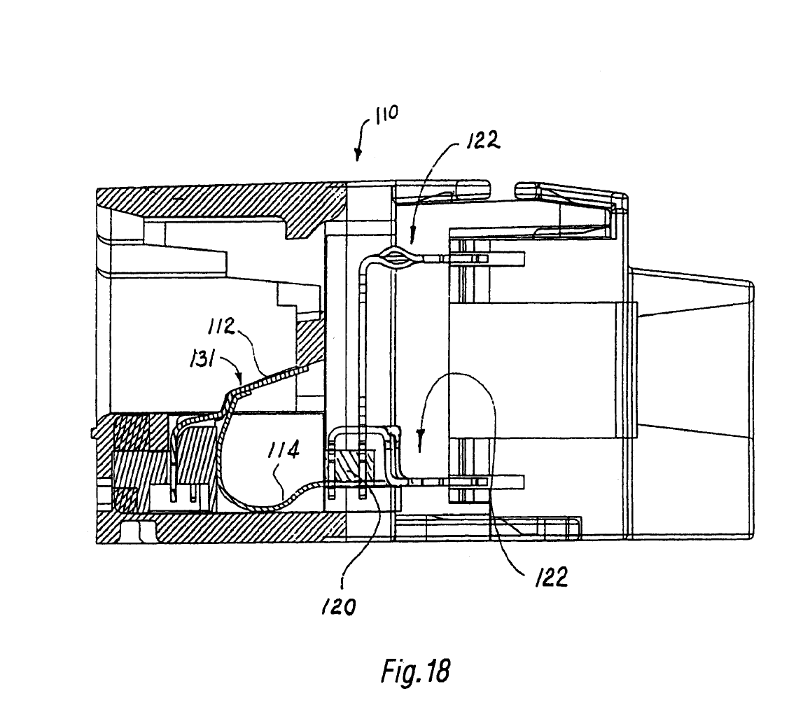

Turning now to FIG. 6, a plan view of an FPC 114 according to one embodiment of the present invention is shown. Jack contact points 130 include solder rivets 131 for electrical resistance welding to jack contacts. The jack contact points 130 are numbered one through eight to correspond to eight conductors (provided in four pairs), and IDC sockets 132 are numbered correspondingly. Conductive traces 138 are provided on the FPC 114. The FPC 114 is adapted for use in a “horizontal extension” embodiment of a jack as shown in FIGS. 18-22.

The FPC 114 electrically connects each jack contact to an IDC and it provides compensation for the crosstalk couplings of a specification plug. It utilizes the teachings of U.S. Pat. No. 5,997,358 to provide said compensation. The FPC 114 is divided into zones as shown in FIG. 6.

The critical pair compensation is for conductor pairs 3,6 to 4,5 as shown in FIG. 6. The zone descriptions below pertain to these pairs and the following statements regarding couplings pertain to couplings between these pairs. The regions of Zones A, B, C, D, E, and F are shown in FIG. 6 with dotted boxes and plan views of the conductive traces in Zones A-F are shown in FIGS. 6A-6F, respectively.

Zone A is a transition zone from the connection to the jack contacts 112 (shown in FIG. 18) to the near-end crosstalk (NEXT) compensation zone.

Zone B is the NEXT compensation zone.

Zone C is a transition zone from the NEXT compensation zone to the NEXT crosstalk zone. The design objectives of this zone are to make its inductive and capacitive couplings and the length of the circuit paths equal to those of Zone A.

Zone E is the NEXT crosstalk zone.

Zone F is a neutral zone which connects the NEXT crosstalk zone to the IDC sockets 32.

The magnitude of the total crosstalk coupling of the NEXT crosstalk zone is approximately equal to that of a specification plug.

The magnitude of the total compensation coupling of the NEXT compensation zone is slightly less than twice the crosstalk coupling of a specification plug plus twice the total coupling of Zone A.

All the above Zones A-C, E, and F have distributed couplings and no remote couplings.

The phase angle change between the effective center of couplings of a specification plug and the center of the NEXT compensation zone is approximately equal to the phase angle change between the center of the NEXT crosstalk zone and the NEXT compensation zone.

The combination of the jack and a specification plug is therefore symmetrical about the center of the NEXT compensation zone.

The result of the above is that Forward NEXT is equal to Reverse NEXT.

Since the NEXT compensation zone is connected to the plug/jack interface by short circuit paths in the FPC, the phase angle change between them is minimized and the change in compensation vs. frequency is minimized.

The total inductive coupling of the NEXT compensation zone is approximately equal to the total inductive couplings of the balance of the circuit path of the jack and a specification plug. The result is a very low FEXT.

The flexibility of the FPC allows it to be connected to all the jack contacts which do not move exactly in unison when a plug is installed. It also facilitates connection to various orientations of IDCs or to a printed circuit board (PCB). The relatively thin dielectric layer of the FPC as compared to that of a PCB facilitates a high density of inductive and capacitive couplings which facilitates a relatively short NEXT compensation zone.

The length of the NEXT compensation zone is preferably approximately equal to the length of the NEXT crosstalk zone. The result is that variations in FPC trace width, which tend to be consistent on an individual FPC, change the capacitive coupling of the NEXT compensation zone and the NEXT crosstalk zone by approximately the same magnitude. This minimizes the compensation variation due to trace width variation.

Zone D is a compensation zone to compensate for the jack contacts. It provides remote capacitive coupling which is connected close to the plug/jack interface.

The circuit paths for pairs 1,2 & 7,8 as shown in FIG. 6 illustrate one way in which compensation between these pair combinations can be attained. The required compensation for these other pairs is much more easily attained than that for pairs 3,6 to 4,5.

FIGS. 6H-6O respectively show conductive traces associated with conductors 1-8, with traces on an upper level of the FPC 114 shown in solid lines and traces on a lower level of the FPC 114 shown in dashed lines. Vias 117 are conductive routes from the upper level to the lower level of the FPC 114. The lengths of conductive traces for pairs 3, 6 and 4, 5 are approximately equal.

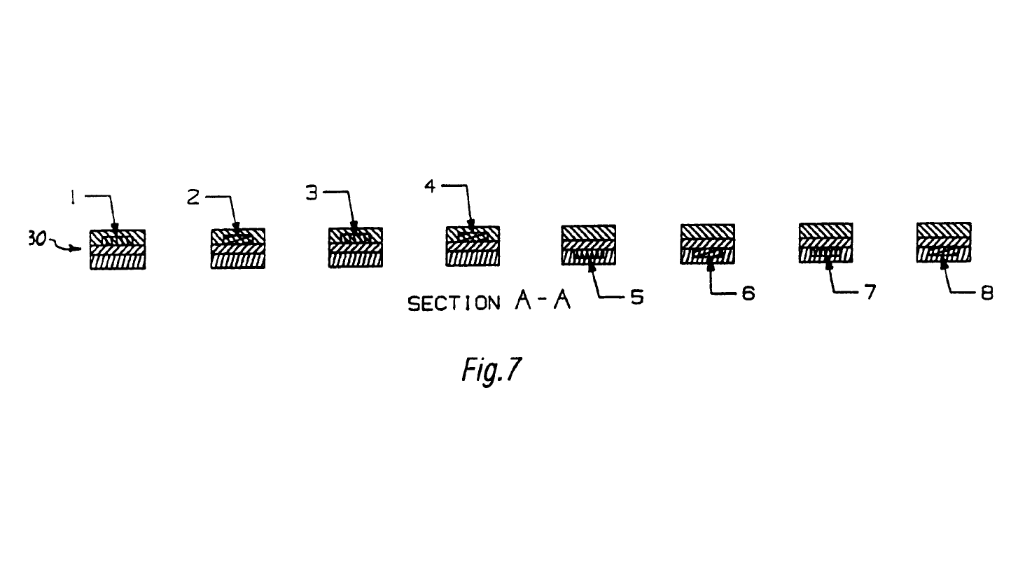

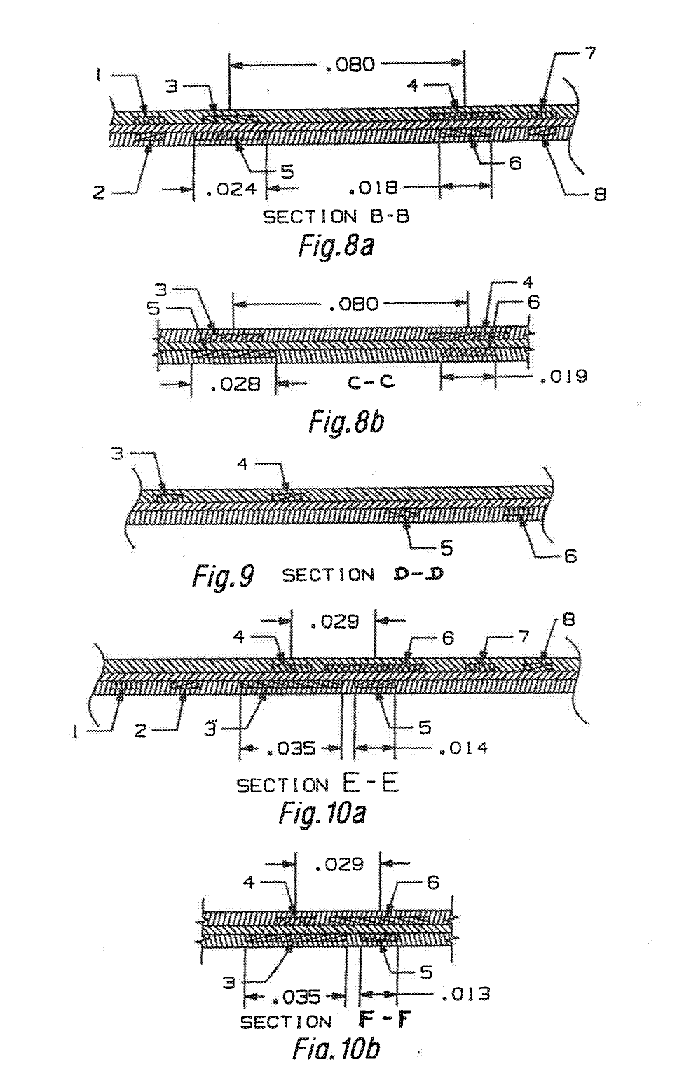

Turning now to FIG. 7, a cross-sectional view along the line A-A of FIG. 6G, shows cross-sections of the jack contact points 130 of the FPC 114. Similarly, FIG. 8A is a cross-sectional view along the line B-B of FIG. 6G. FIG. 8B is a cross-sectional view along the line C-C of FIG. 6G.

FIG. 9 is a cross-sectional view along the line D-D of FIG. 6G.

FIG. 10A is a cross-sectional view along the line E-E of FIG. 6G.

FIG. 10B is a cross-sectional view along the line F-F of FIG. 6G.

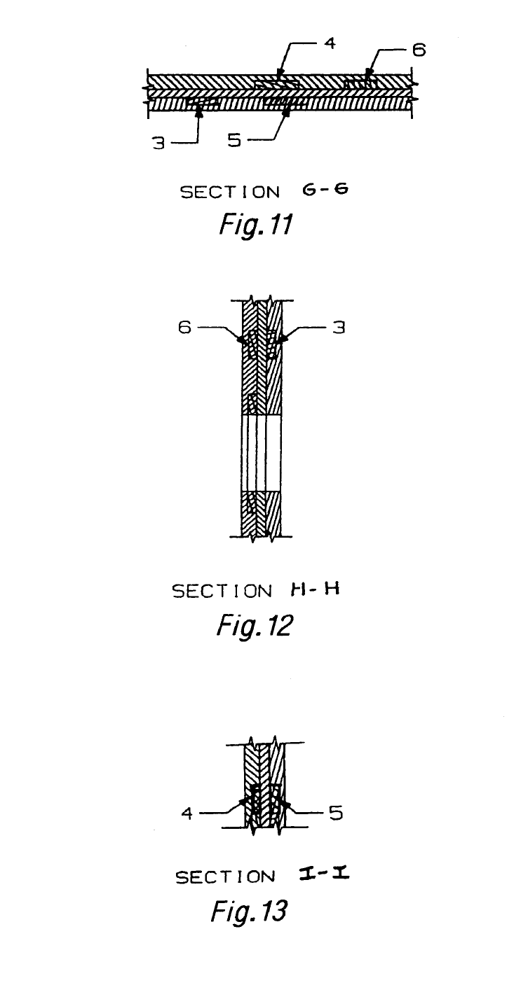

FIG. 11 is a cross-sectional view along the line G-G of FIG. 6G.

FIG. 12 is a cross-sectional view along the line H-H of FIG. 6G.

FIG. 13 is a cross-sectional view along the line I-I of FIG. 6G.

The numbers one through eight associated with the conductive traces in FIGS. 7-13 show that the referenced conductive traces correspond to the jack contact points 130 of the FPC 114 and, in turn, with the corresponding conductors to which the jack is connected.

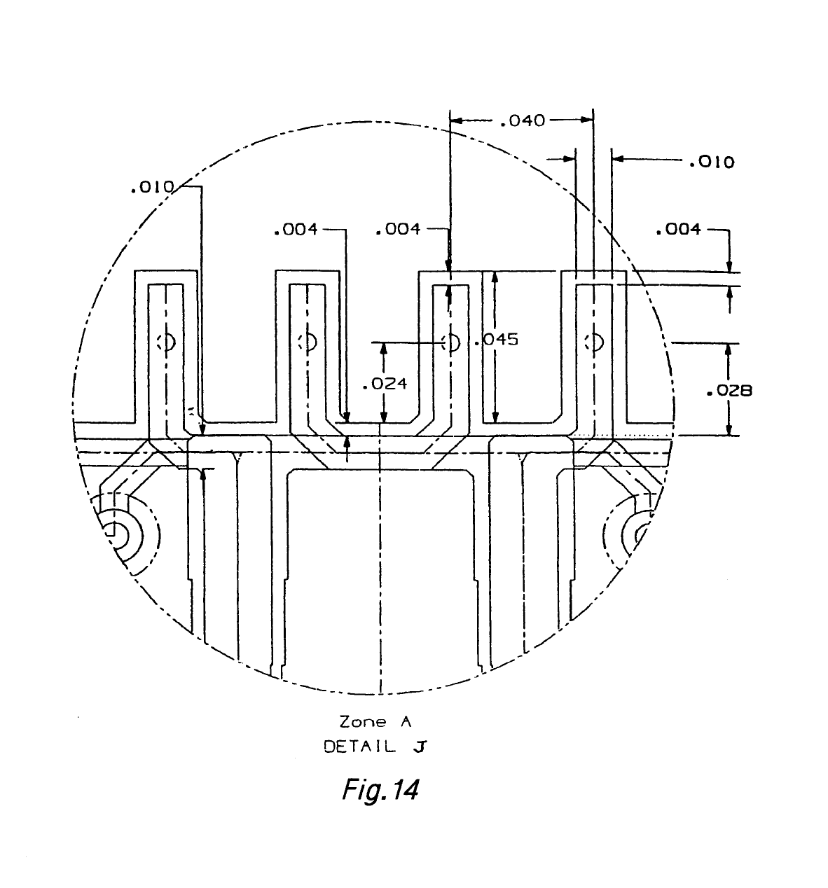

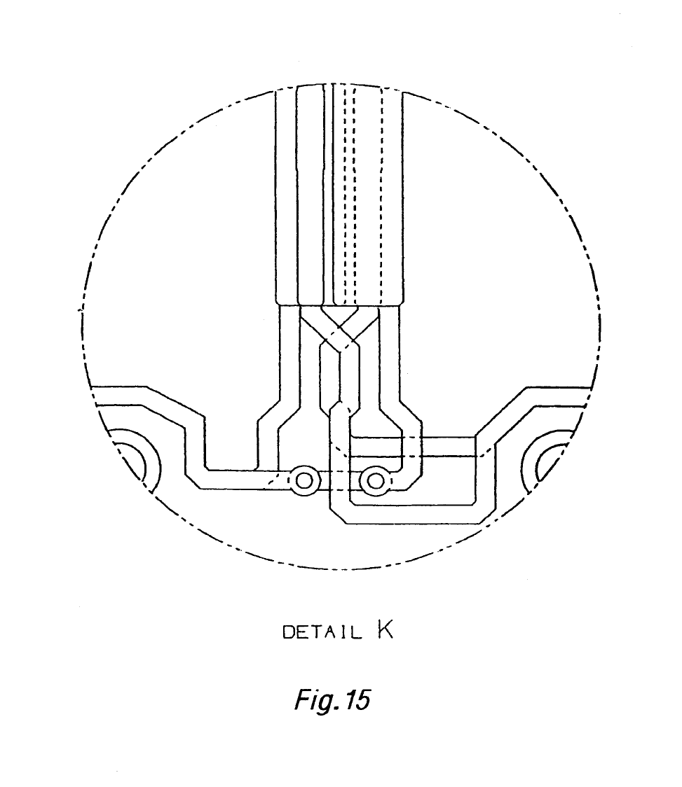

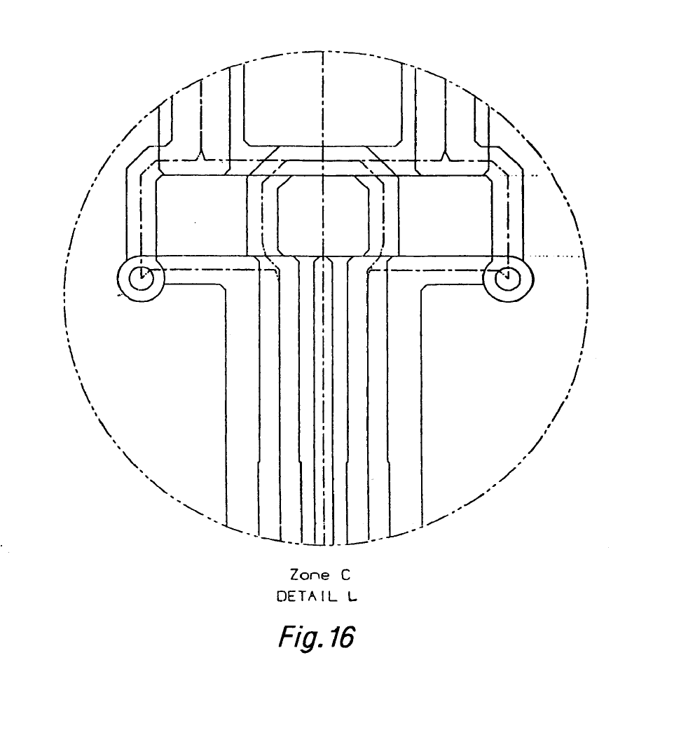

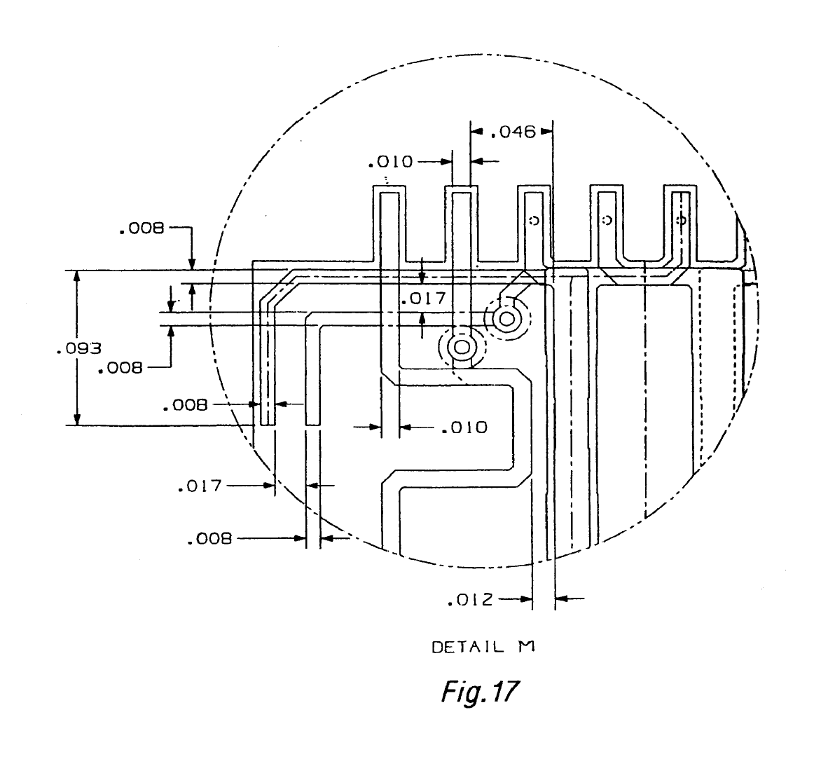

FIGS. 14-17 are, respectively, detail views of detail areas J, K, L, and M of FIG. 6G. Dimensions shown in FIGS. 6G and 7-17 are in inches and are provided for illustration of one particular embodiment of the present invention. It is to be understood that embodiments having different dimensions are contemplated as falling within the scope of the present invention.

Turning now to FIG. 18, a cross-sectional view of a jack 110 having a horizontal extension 120 of the FPC 114 is shown. As with the embodiment of FIG. 1, the contacts 112 make electrical and mechanical contact with the FPC 114 and the plug-jack interface 131 is disposed directly above the contact between the contacts 112 and the FPC 114. IDCs 122 are inserted into IDC sockets of the horizontal extension 120 of the FPC 114. Other styles of terminations, such as punch-down terminations, may also be used with the present invention.

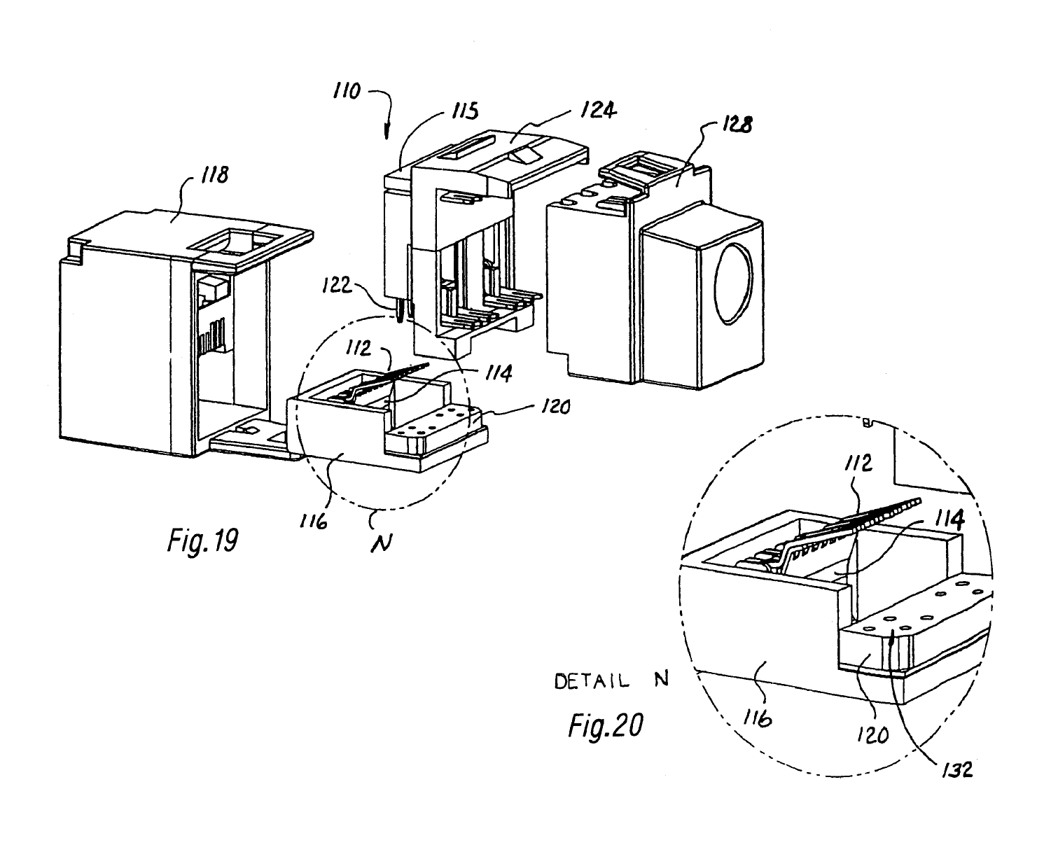

FIG. 19 is an exploded view of the jack 110. A main jack housing 118 is adapted to hold a sled 116 with contacts 112 mounted therein. An IDC block assembly 115 is attached to a rear housing 124 and a termination cap 128 is provided at the rear of the jack 110. The extension 120 of the FPC 114 is disposed horizontally to accept IDCs 122. FIG. 20 is a detail view of the detail N of FIG. 19 showing the FPC 114 making electrical and mechanical contact with the contacts 112 and further showing IDC sockets 132 adapted to connect to IDCs 122.

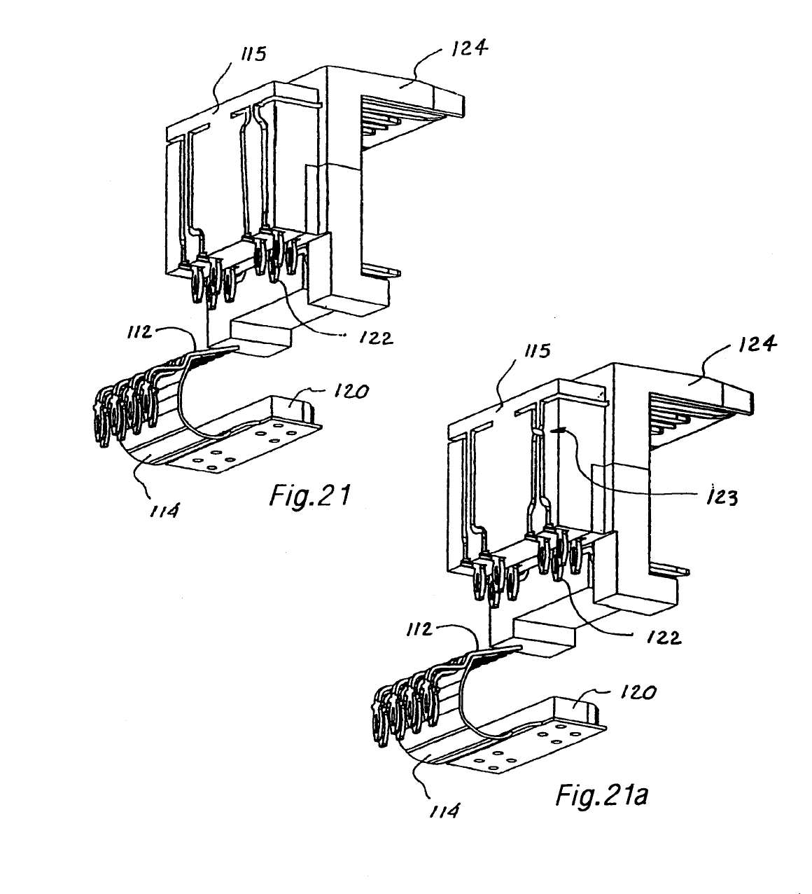

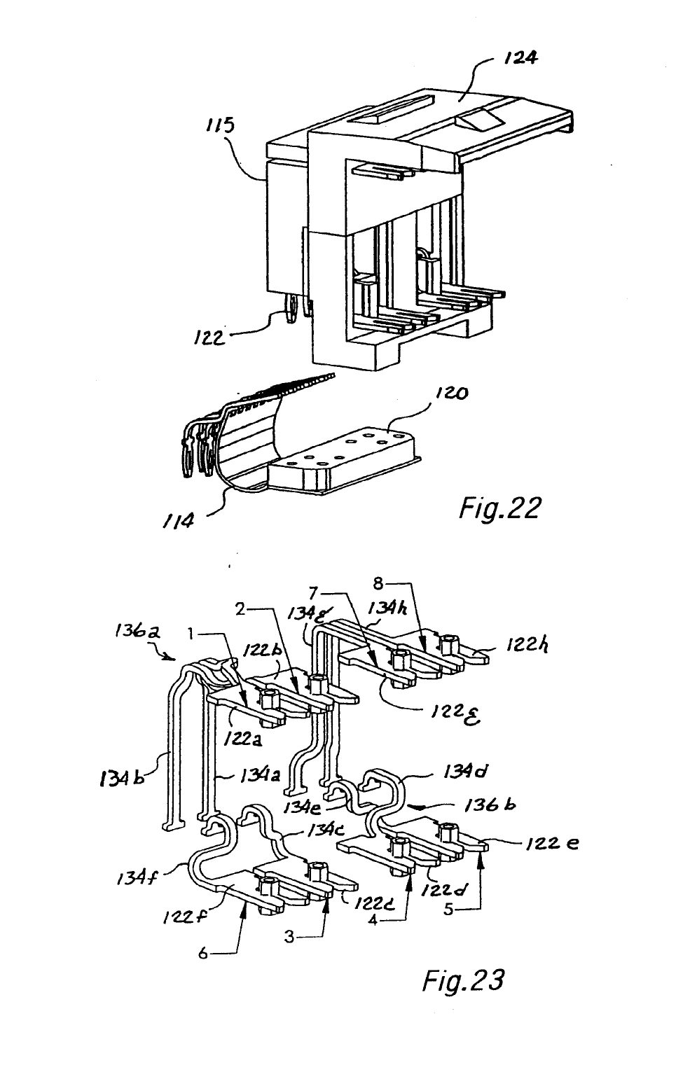

FIGS. 21, 21A, and 22 are perspective views showing the housing 124, the IDC block assembly 115, the contacts 112, and the FPC 114 with its horizontally-oriented rigid extension 120. In an alternative embodiment, as shown in FIG. 21A, one or more pairs of IDCs 122 may be provided with crossover stems 123 in the IDC block assembly 115.

According to one embodiment of the present invention, illustrated in FIG. 23, IDCs 122 are provided with stems 134, with some stems 134 incorporating crossovers 136. FIG. 23 is a perspective view showing IDCs 122a-h corresponding, respectively, to first through eighth conductors of a jack. First through eighth stems 134a-h correspond respectively to first through eighth IDCs 122a-h. First and second stems 134a and 134b cross over each other at a first crossover 136a, and fourth and fifth stems 134d and 134e cross over each other at a second crossover 136b.

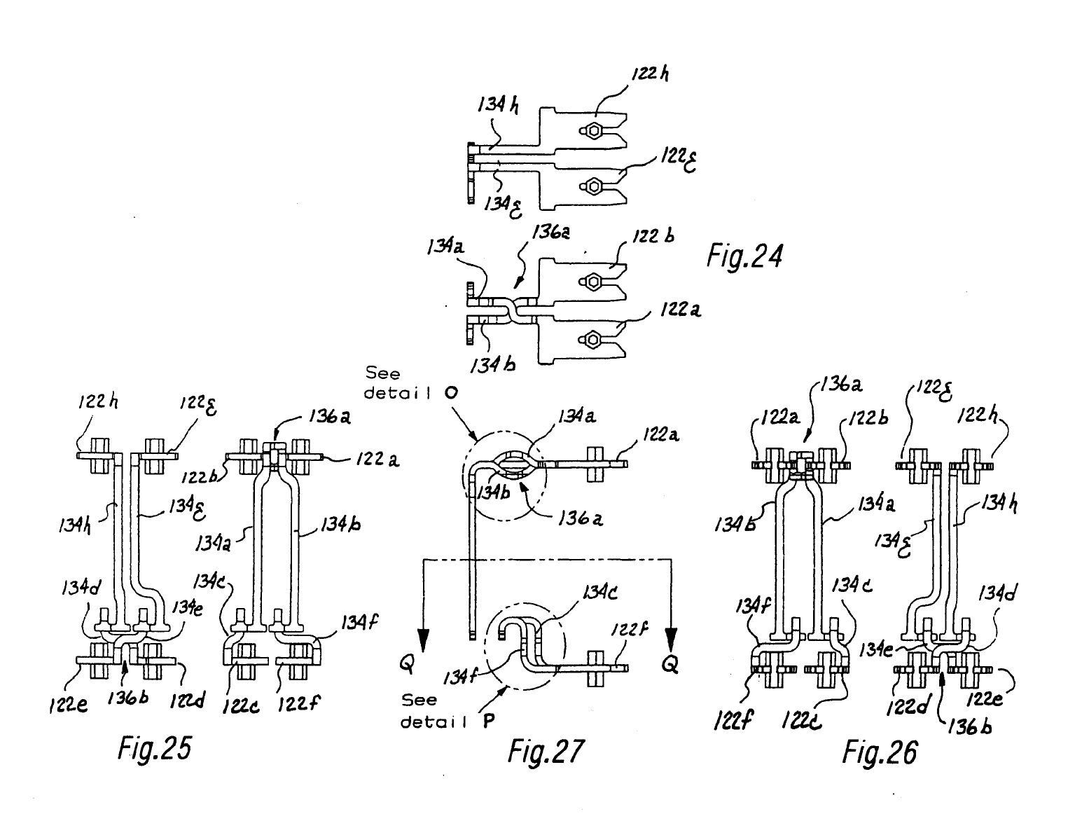

FIG. 24 is a top view of the first, second, seventh, and eighth IDCs 122a, 122b, 122g and 122h showing the first crossover 136a in the first and second stems 134a and 134b.

FIG. 25 is a front view of the IDCs 122a-h and their associated stems 134a-h showing first and second crossovers 136a and 136b. FIG. 26 is a rear view of the IDCs 122a-h showing the features of FIG. 25.

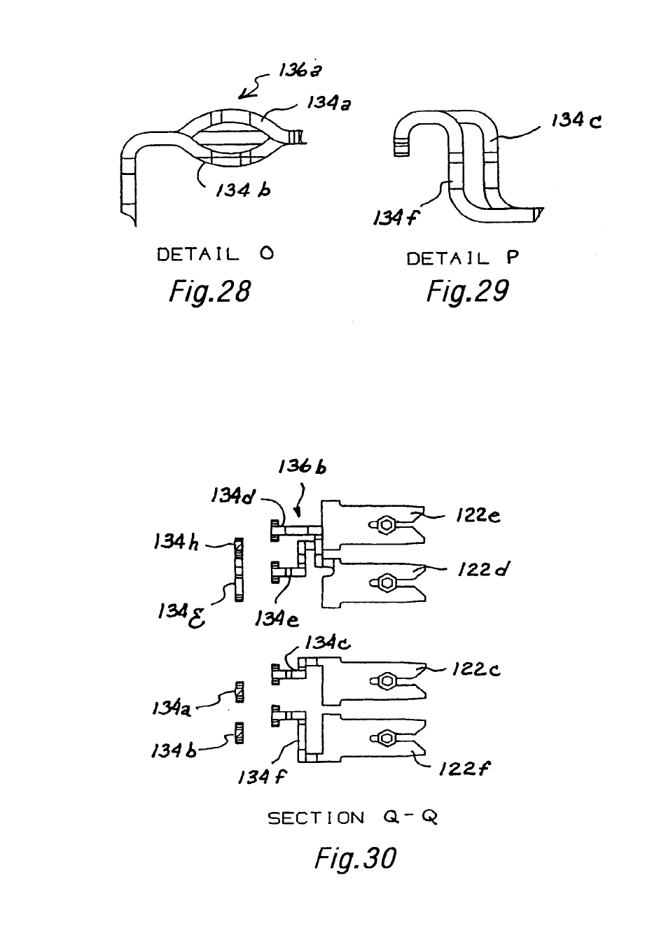

FIG. 27 is a side view of the embodiment of FIG. 23 showing IDCs and associated stems. The first crossover 136a between first and second stems 134a and 134b is shown. FIG. 28 is a view of the detail O of FIG. 27 showing the first crossover 136a. FIG. 29 is a view of the detail P of FIG. 27 showing the third and sixth stems 134c and 134f. FIG. 30 is a sectional view of the section Q-Q of FIG. 27, showing third, fourth, fifth, and sixth IDCs 122c-f with their associated stems 134c-f and further showing the second crossover 136b between the fourth and fifth stems 134d and 134e. Sections of the first, second, seventh, and eighth stems 134a, 134b, 134g, and 134h are also shown in FIG. 30.

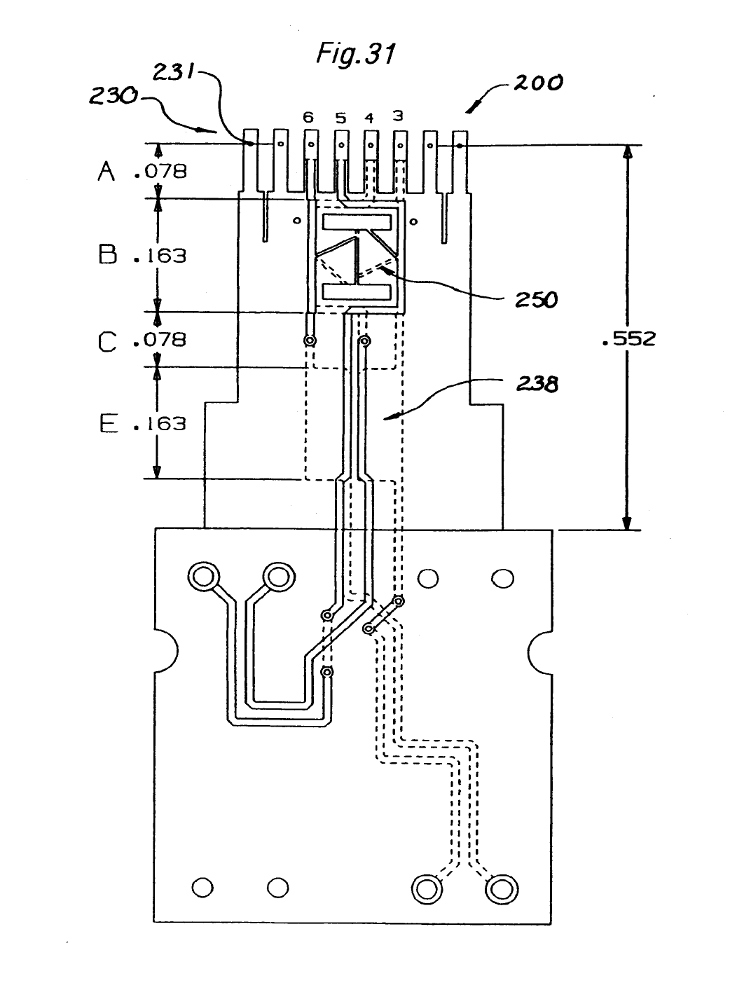

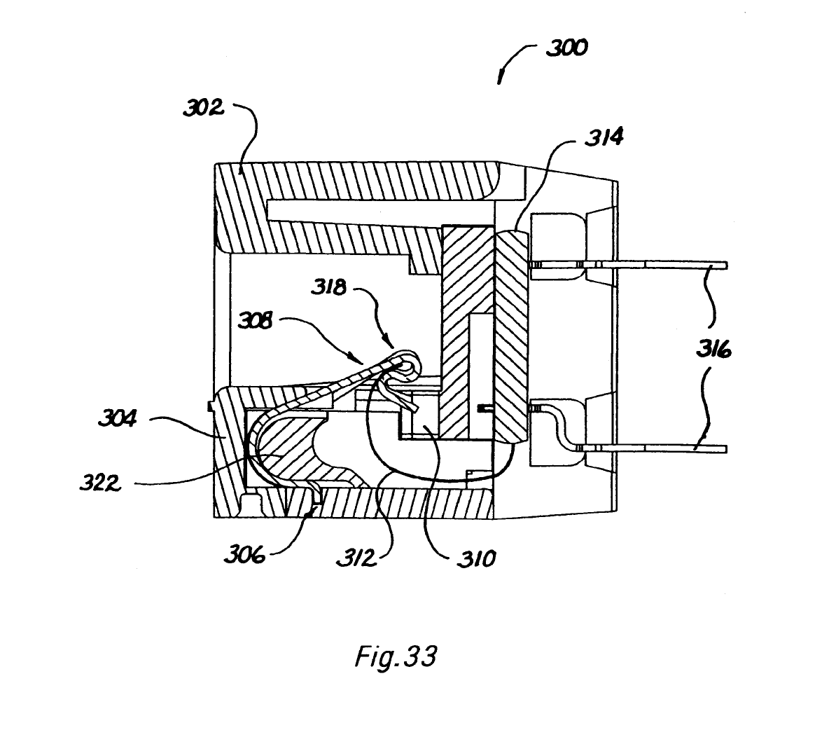

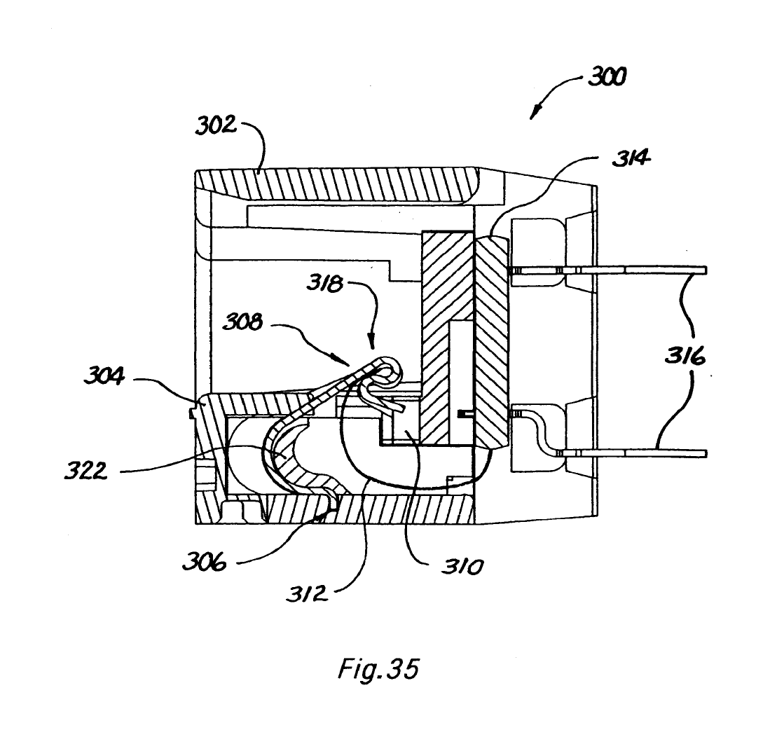

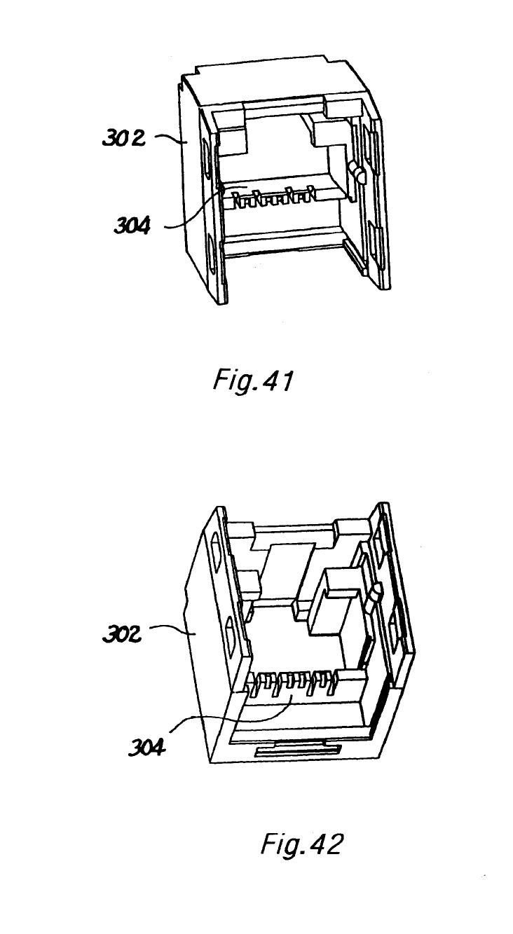

FIG. 31 is a plan view of an alternative FPC 200, which may be used with the jack shown in FIGS. 33-45. Jack contact points 230 include vias (plated through holes) 231 for electrical connection to jack contacts. The jack contact points 230 correspond to eight conductors (provided in four pairs). Only four (conductors 3, 4, 5, and 6) are shown in FIG. 31. Conductive traces 238 are provided on the FPC 200. The FPC 200 is adapted for use in a “vertical extension” embodiment of a jack as shown in FIGS. 33-45.

The FPC 200 electrically connects each jack contact to an IDC and it provides compensation for the crosstalk couplings of a specification plug. It utilizes the teachings of U.S. Pat. No. 5,997,358 to provide said compensation. The FPC 200 is divided into zones as shown in FIG. 31.

The critical pair compensation is for conductor pairs 3,6 to 4,5 as shown in FIG. 31. The zone descriptions below pertain to these pairs and the following statements regarding couplings pertain to couplings between these pairs. The regions of Zones A, B, C, D, and E are shown in FIG. 31. These Zones are identified below, but the functions are described above, with reference to FIGS. 6-17.

Zone A is a transition zone from the connection to the jack contacts to the near-end crosstalk (NEXT) compensation zone.

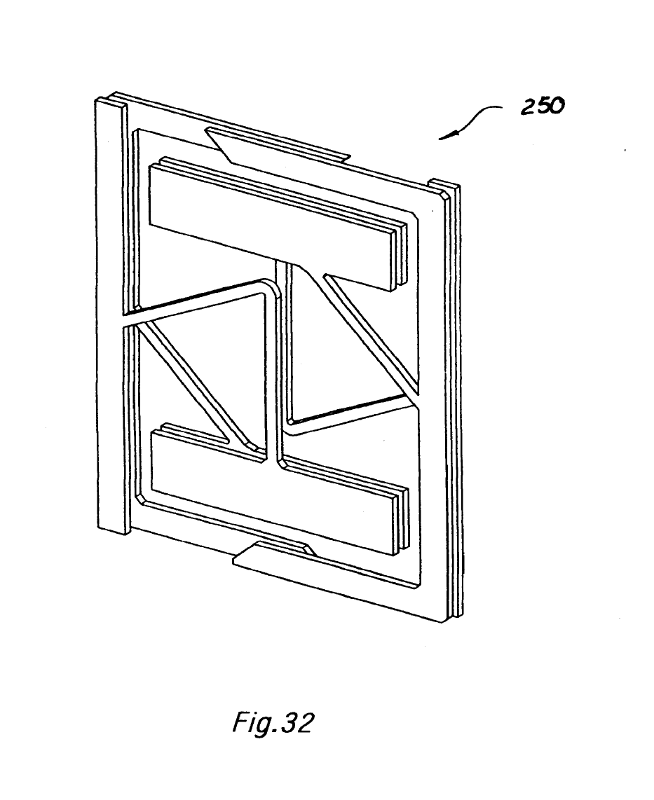

Zone B is the NEXT compensation zone. As illustrated, it includes an optional variable capacitance 250 (described below, with reference to FIG. 32).

Zone C is a transition zone from the NEXT compensation zone to the NEXT crosstalk zone. The design objectives of this zone are to make its inductive and capacitive couplings and the length of the circuit paths equal to those of Zone A.

Zone E is the NEXT crosstalk zone.

The traces below Zone E in FIG. 31 make up a neutral zone that connects the NEXT crosstalk zone (Zone E) to the IDC sockets.

FIG. 32 is a perspective view of the variable capacitance 250 shown in FIG. 31. The variable capacitance 250 provides a capacitive coupling that effectively decreases as frequency increases. FIG. 32 is an upper perspective view of this portion showing the capacitive plates, with the substrate removed for ease of illustration. In general, the distributed coupling of the compensation zone would be reduced by the magnitude of capacitive change of the remote coupling of variable capacitance 250. The technology of the variable capacitive coupling is described in U.S. patent application Ser. No. 60/559,846, entitled “Electrical Connector with Improved Crosstalk Compensation,” filed on Apr. 6, 2004 and incorporated herein by reference in its entirety.

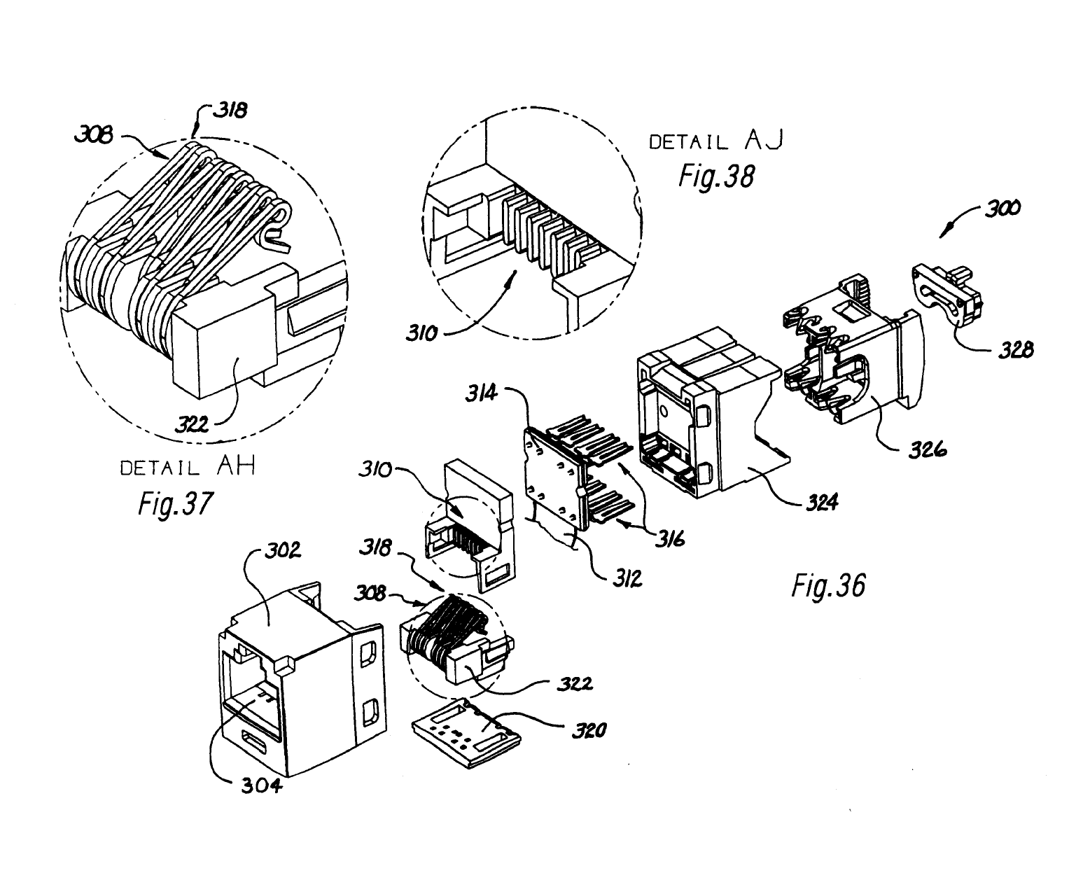

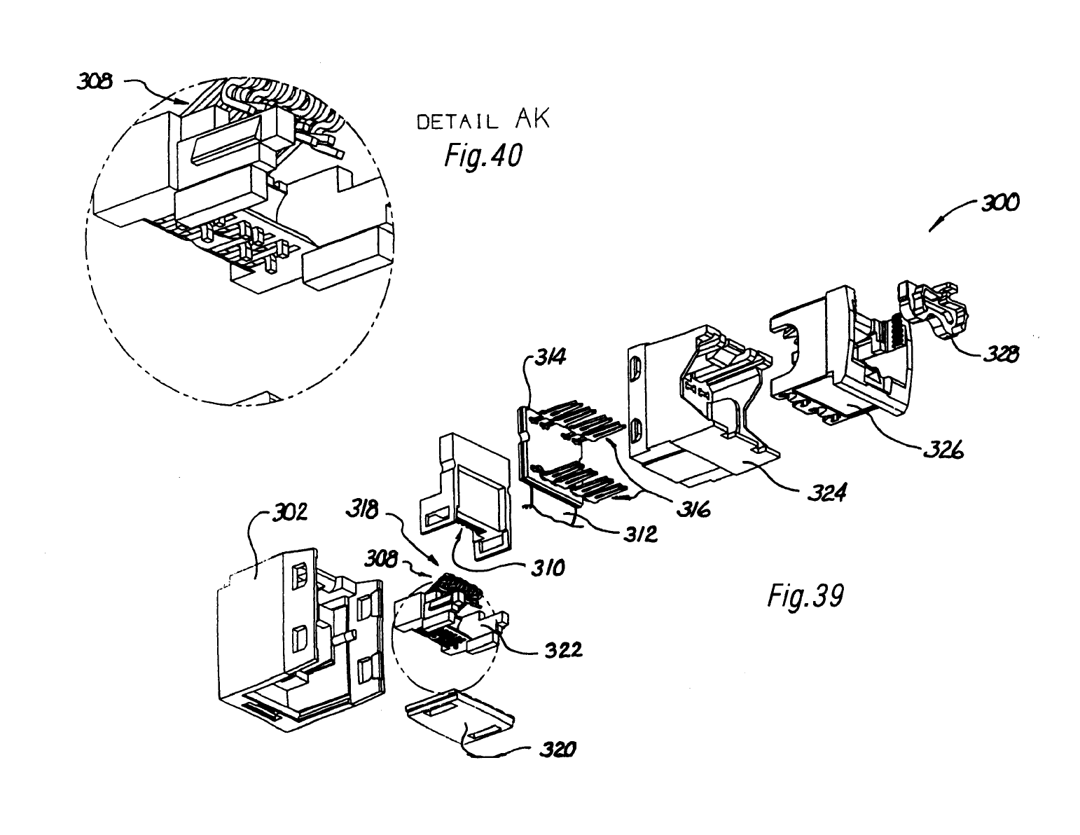

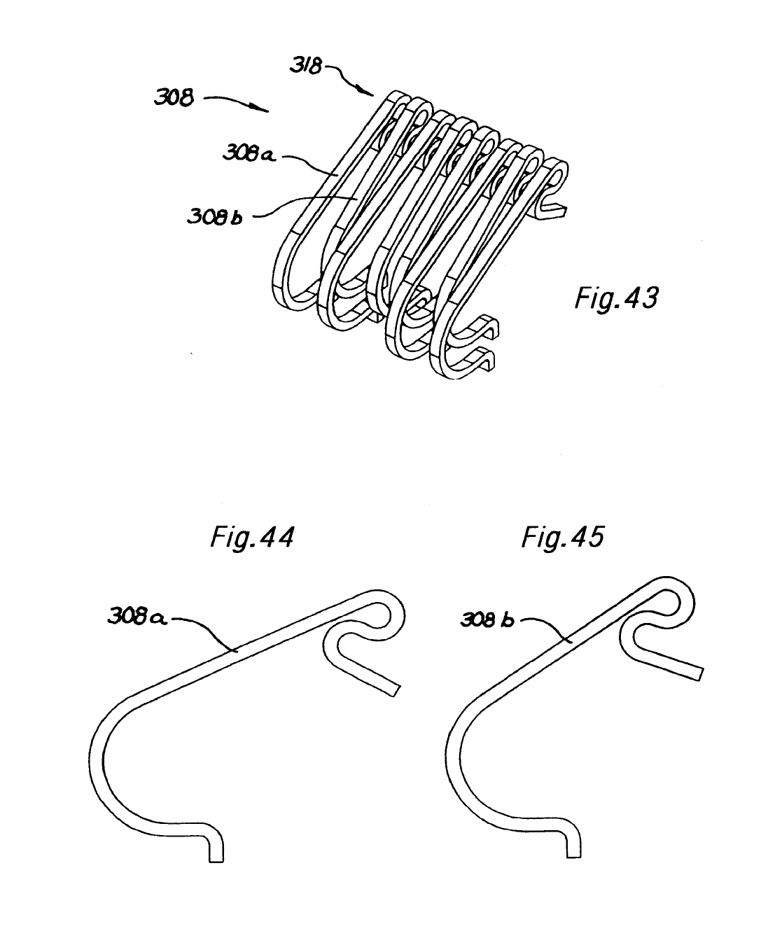

FIGS. 33-45 are various views of an illustrative embodiment of the present invention, in which alternating-length contacts include integral spring clips for connecting to a flexible printed circuit (FPC). FIGS. 33-35 are side cutaway views of a portion of such a jack. FIGS. 36 and 39 are exploded perspective views of a complete jack. FIGS. 37, 38, and 40-42 are detailed perspective views of components of the jack. FIGS. 43-45 show details of the jack contacts (also known as plug interface contacts).

The jack 300 includes a housing 302 that includes an integral front comb 304 and “sandwich-style” contact mounts 306 to hold and position a plurality of contacts 308. The front comb 304 limits the upward travel of the contacts 308. Each of the contacts 308 has a corresponding rear contact guide 310 into which the contacts 308 may travel upon insertion of a plug (not shown) into the jack 300. A FPC 312 is electrically and mechanically connected at one end to a printed circuit board (PCB) 314, which further connects to IDCs 316 that connect to a network cable (not shown). A second end of the FPC 312 is connected to the contacts 308 by a plurality of spring contacts 318. Each of the spring contacts 318 is preferably s-shaped to securely hold the FPC 312 so that a good electrical connection is maintained between the contacts 308 and the FPC 312. The jack further includes a bottom mounting plate 320 for mounting a front sled (around which contacts 308 are placed) in the housing 302. A rear sled 324 mechanically connects the housing (and components housed therein) to a wire cap 326 designed to accept a network cable for placement of individual wires (not shown) in the IDCs 316. In the particular wire cap 326 shown, a strain relief clip 328 securely holds the network cable in place, lessening strain on the individual wires within the network cable. The particular arrangement of the rear sled 324, wire cap 326, and strain relief clip 328 is shown as an example only. Many other designs could also be used, including those for a punch-down jack.

An advantageous feature of the jack 300 described with reference to FIGS. 33-45 is the use of contacts 308 having alternating lengths. As shown in FIGS. 43-45, half of the contacts 308a are longer in length than the other half 308b. While the spring contacts 318 on each contact 308 are aligned with one another, the lower portions that wrap around the front sled 322 for mounting in the contact mounts 306 substantially alternate from one end of the front sled 322 to the other. The middle two contacts 308 are the only two neighboring contacts 308 that have the same length, in the preferred embodiment. The difference in length between neighboring contacts 308a and 308b results in the contacts 308a and 308b being situated at different locations in relation to one another. This, in turn, reduces the capacitive couplings between contact pairs, which reduces crosstalk. To accommodate the different contacts 308a and 308b, the front comb 304 and front sled 322 are designed for both lengths of contacts.

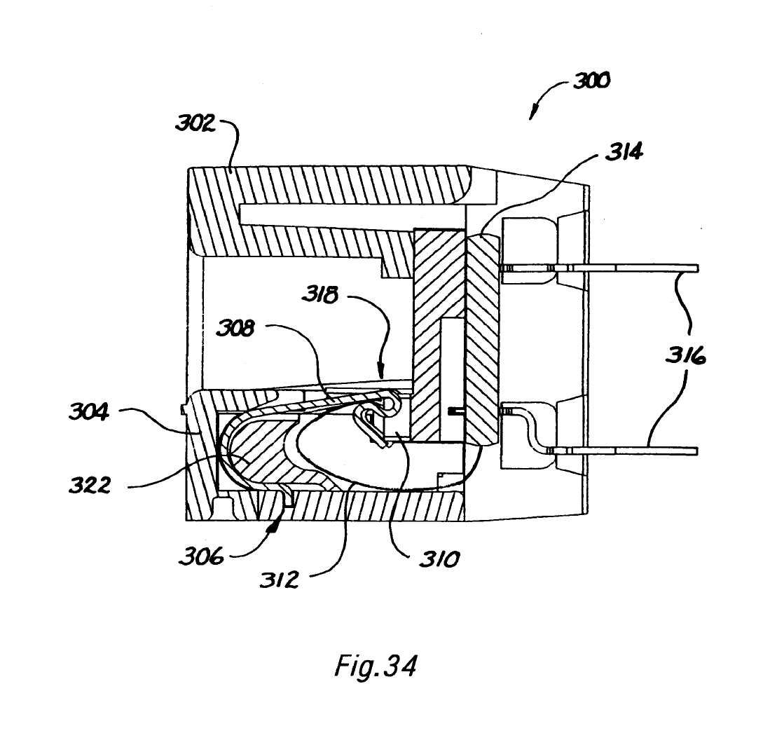

Another feature of the design of contacts 308 is that those corresponding to wires 1 and 8 (the outside contacts) are both of the longer length. This helps to accommodate both 8-position plugs (in which contacts 1 and 8 make electrical connection with corresponding contacts in the plug) and 6-position plugs (in which contacts 1 and 8 are pushed down by a solid plastic portion that is common on most 6-position plugs). See FIG. 34 for an illustration of contact 1 or 8 with a 6-position plug inserted.

The spring contacts 308 provide an alternative FPC connecting mechanism to that described in other embodiments set forth herein (i.e. welding, etc.). During manufacture (or installation) the FPC 312 may be inserted into some or all of the spring contacts 318. The spring contacts 318 provide a holding force that pinches the FPC to hold it in place to allow a good electrical connection.

The disclosed invention provides an electrical connector employing crosstalk-reduction techniques. It should be noted that the above-described and illustrated embodiments and preferred embodiments of the invention are not an exhaustive listing of the forms such the invention might take; rather, they serve as exemplary and illustrative embodiments of the invention as presently understood. By way of example, and without limitation, the jack 110 of FIGS. 18-22 may be manufactured with a forward bend in the FPC 114, similar to the forward bend 34 shown in FIG. 5.

One advantage of the present invention is that by having the signal perpetuate generally orthogonal to the plug interface contacts through the flexible printed circuit board, a shorter distance to compensation is enabled.

Another embodiment is an RJ45 network jack in which the plug interface contact (PIC) interface for contacts 3 and 6 is formed using a thin layer of contact material that is electrically insulated and wrapped over conductive mechanical spring contact that is connected to contact 6 and 3 respectively. The spring contact support at PIC position 3 is electrically connected to PIC interface 6 and spring contact support at position 6 is electrically connected to PIC interface 3. The PIC interface connection to spring contact is made such that it does not interfere with the plug mating. Reduced PIC interface thickness at position 3 and 6 reduces 2-3, 3-4, 5-6 and 6-7 crosstalk. PIC position 3 and 6 supports having connected to position 6 and 3 respectively, provides crosstalk compensation 2-6, 4-6, 3-5, and 3-7 close to the plug/jack mating interface.

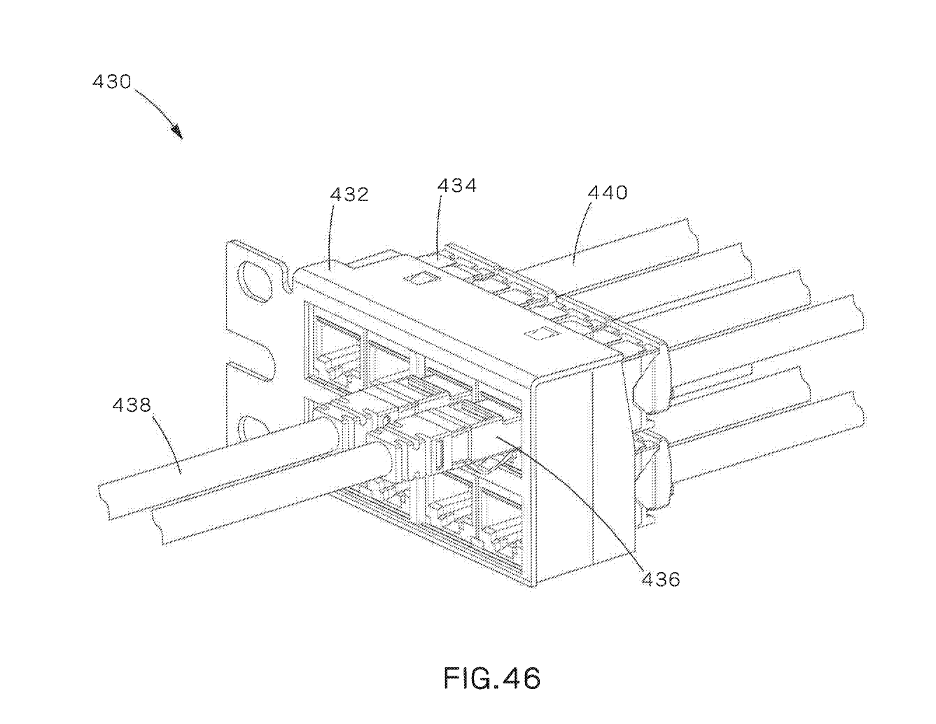

FIG. 46 illustrates a communication system 430 which includes patch panel 432 with jacks 434 and corresponding plugs 436. Respective cables 440 are terminated to jacks 434, and respective cables 438 are terminated to plugs 436. Once a plug 436 mates with a jack 434, data can flow in both directions through these connectors. Although communication system 430 is illustrated as a patch panel in FIG. 46, alternatively it can be other active or passive equipment. Examples of passive equipment can be, but are not limited to, modular patch panels, punch-down patch panels, coupler patch panels, wall jacks, etc. Examples of active equipment can be, but are not limited to, Ethernet switches, routers, servers, physical layer management systems, and power-over-Ethernet equipment as can be found in data centers and or telecommunications rooms; security devices (cameras and other sensors, etc.) and door access equipment; and telephones, computers, fax machines, printers, and other peripherals as can be found in workstation areas. Communication system 30 can further include cabinets, racks, cable management, and overhead routing systems, and other such equipment.

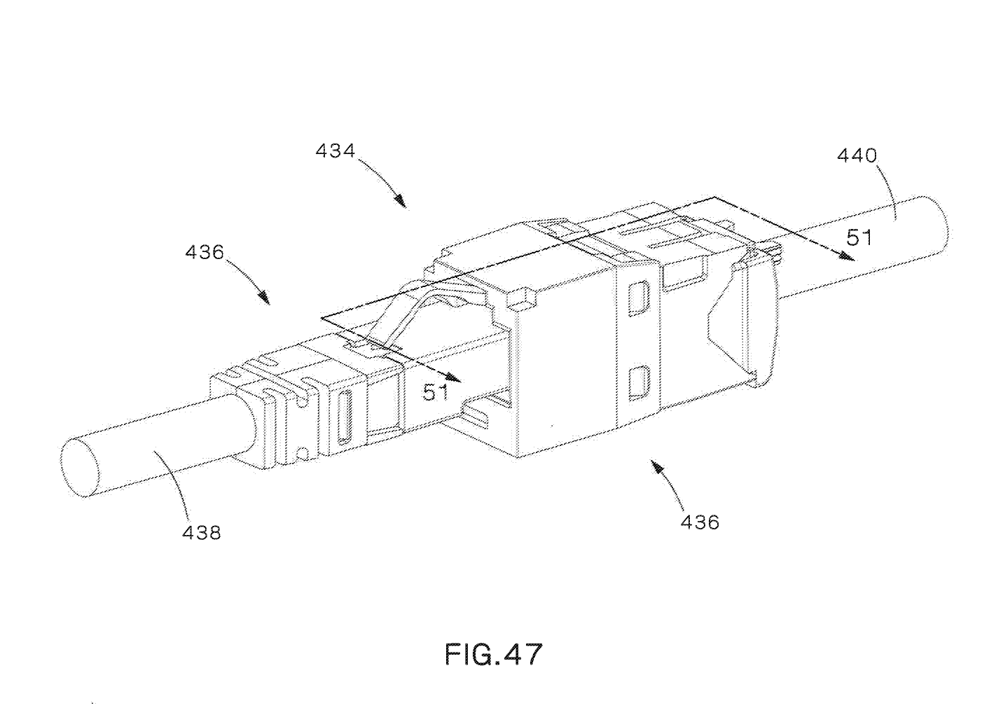

FIG. 47 illustrates network jack 434 mated with RJ45 plug 436. Note that in FIG. 2 the orientation of network jack 434 and RJ45 plug 436 is rotated 180° about the central axis of cable 440 as compared to the orientation from FIG. 46.

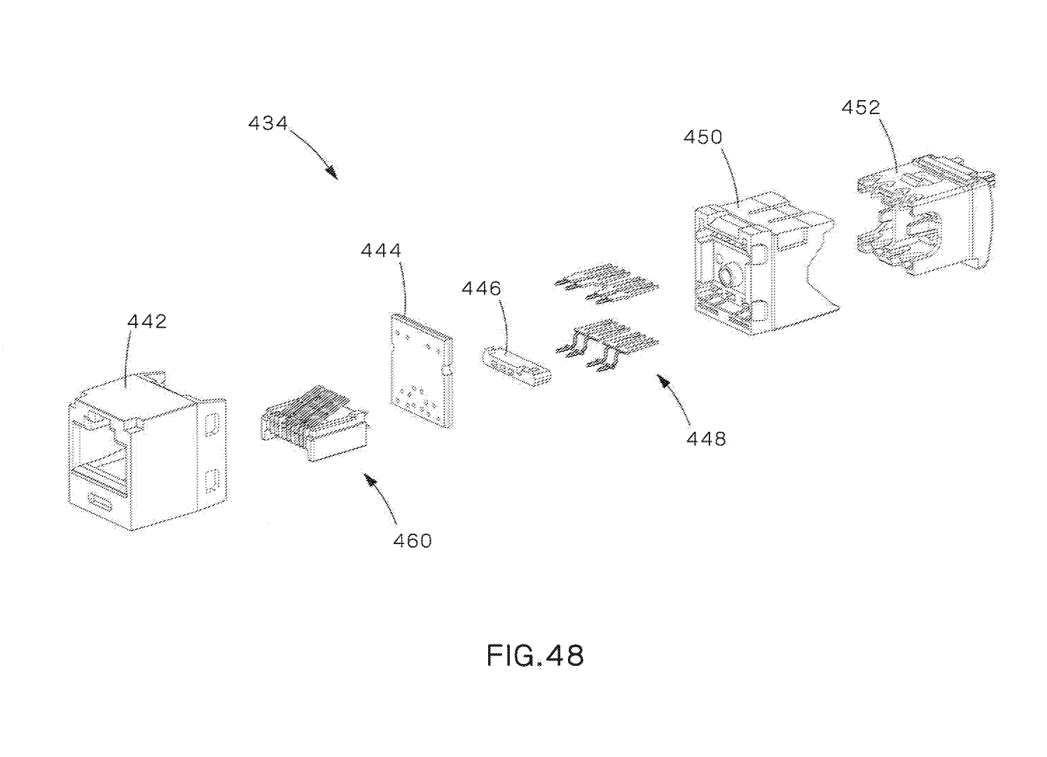

Referring now to FIG. 48, network jack 434 includes front housing 442, front sled assembly 460, PCB 444, insulation displacement contact (IDC) support 446, IDCs 448, rear housing 450, and wire cap 452. Jack 434 can additionally include an alien crosstalk reducing foil as described in U.S. Pat. No. 8,167,661 which is herein incorporated by reference in its entirety.

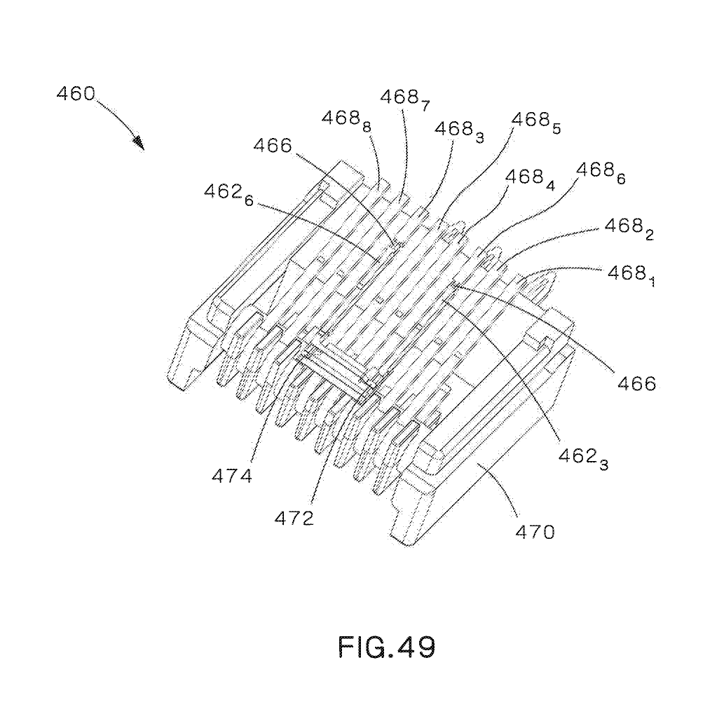

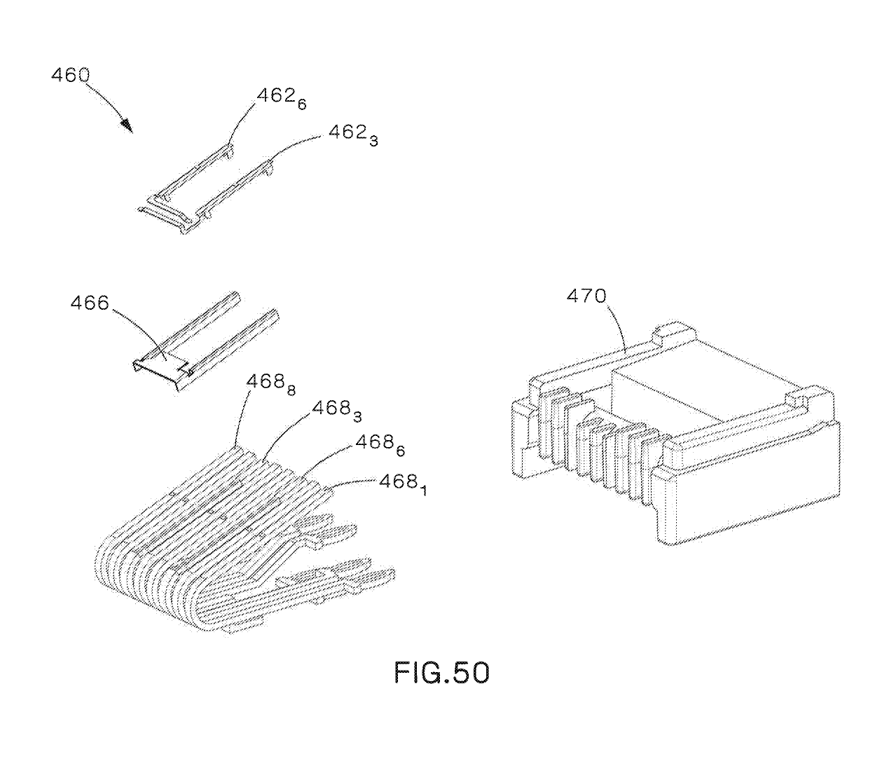

FIG. 49 is a rotated isometric view of front sled assembly 460. It includes PICs 468₁ through 468₈, PIC covers 462₃ and 462₆, insulator 466, and sled 470. The subscript numbers of PICs and PIC covers represent RJ45 pin positions as defined by ANSI/TIA-568-C.2. PIC covers 462₃ and 462₆ interface with plug contacts electrically. PICs 468₆ and 468₃ provide mechanical support at PIC positions 462₃ and 462₆, respectively. Insulator 466 electrically isolates PIC covers 462₃ and 462₆ from PICs 468₆ and 468₃, respectively. PIC cover 462₃ electrically connects to PIC 468₃ at location 474. PIC Cover 462₆ electrically connects to PIC 468₆ at location 472.

FIG. 50 is an exploded view of sled assembly 460 with PICs 468, PIC covers 462, insulator 466, and sled 470.

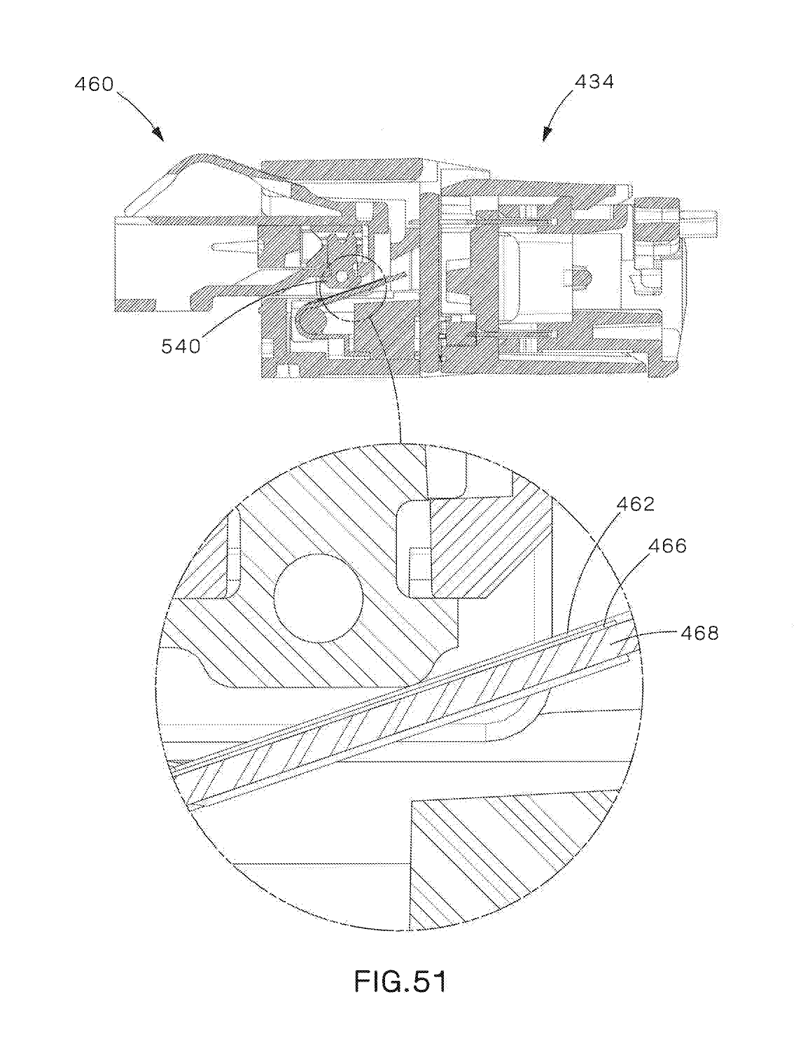

FIG. 51 is a cross-sectional view of a mated plug 436 and jack 434 taken about section line “51-51” in FIG. 47. It illustrates plug contact 540, PIC 468, and PIC cover 462 in a mated position. Insulator 466 electrically isolates PIC cover 462 from PIC 468 at contact positions 3 and 6.

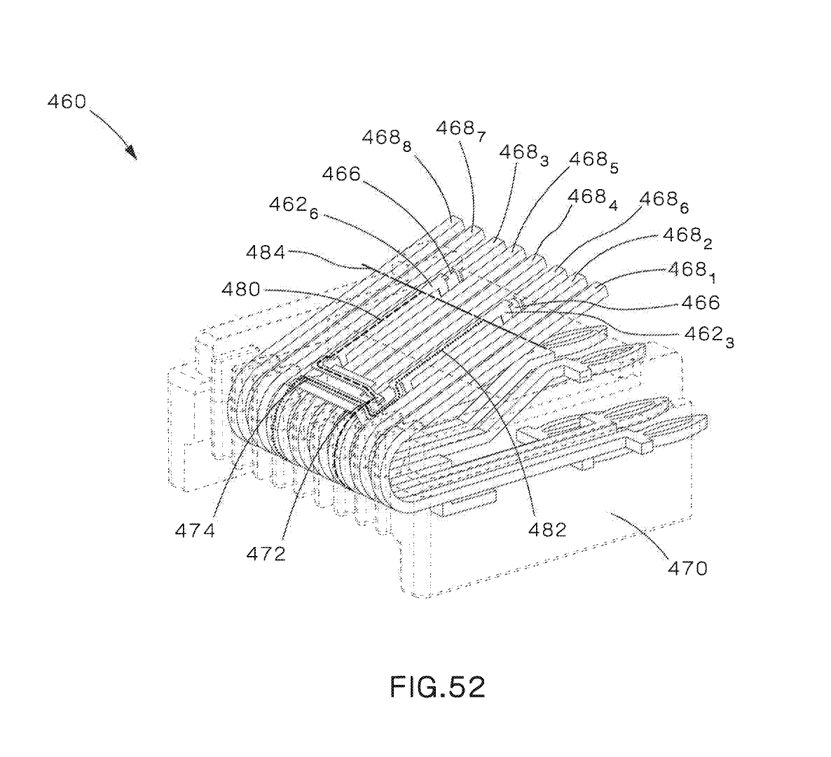

FIG. 52 is an isometric view of sled assembly 460 showing signal path 480 (bold dashed line) for contact position 6 and signal path 482 (bold dotted line) for contact position 3 from plug mating point shown by line 484. Sled 470 is shown as a dashed outline for reference. For contact position 3, PIC cover 462₃ electrically connects to plug contact 3 and to PIC 468₃ at location 474. PIC cover 462₃ is mechanically connected to (but electrically insulated from) PIC 468₆. PIC 468₆ provides spring force to PIC Cover 462₃ at the plug contact interface. PIC 468₆ is located between PIC 468₂ and 468₄ and provides compensating crosstalk coupling 2-6 and 4-6. The relatively small cross section of PIC cover 462₃ reduces 2-3 and 3-4 crosstalk due to its coupling with 468₂ and 468₄. Similarly, for contact position 6, PIC cover 462₆ electrically connects to plug contact 6 and to PIC 468₆ at location 472. PIC cover 462₆ is mechanically connected to (but electrically insulated from) PIC 468₃. PIC 468₃ provides spring force to PIC Cover 462₆ at the plug contact interface. PIC 468₃ is located between PIC 468₇ and 468₅ and provides compensating crosstalk coupling 3-7 and 3-5. The relatively small cross section of PIC cover 462₆ reduces 5-6 and 6-7 crosstalk due to its coupling with 468₅ and 468₇. In addition, PIC cover 462₃ coupling with PIC 468₆ and PIC cover 462₆ coupling with PIC 468₃ helps to offset the impedance mismatch due to the 3-6 pair split, resulting in improved return loss performance.

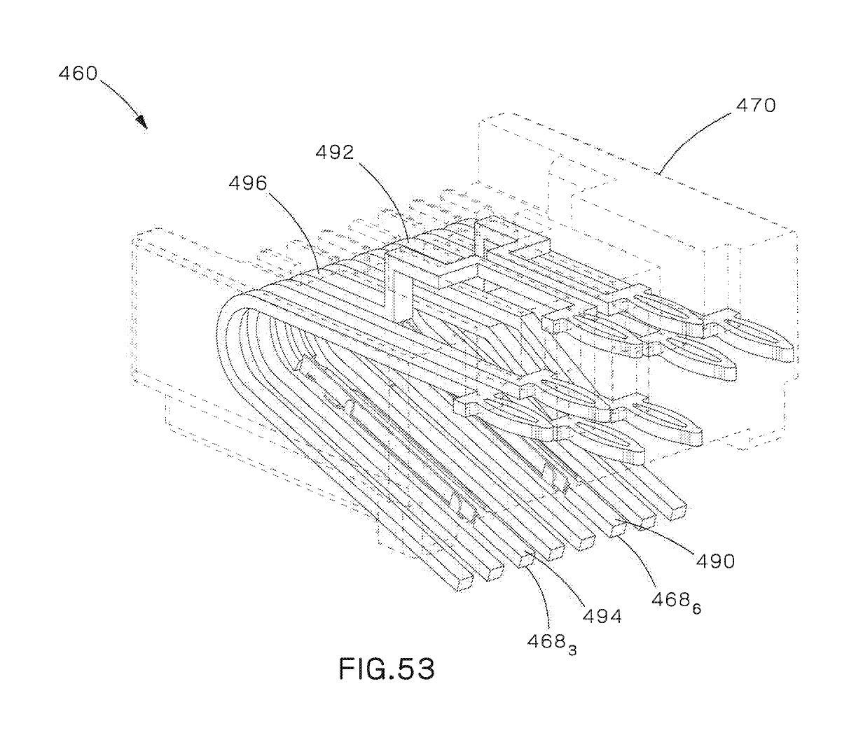

FIG. 53. is an isometric view of sled assembly 460 looking from the bottom. It shows contact 468₃ and 468₆ with tuning lengths 494, 496 and 490, 492 respectively. Tuning length can be optimized in width and/or length to have desired compensation coupling.

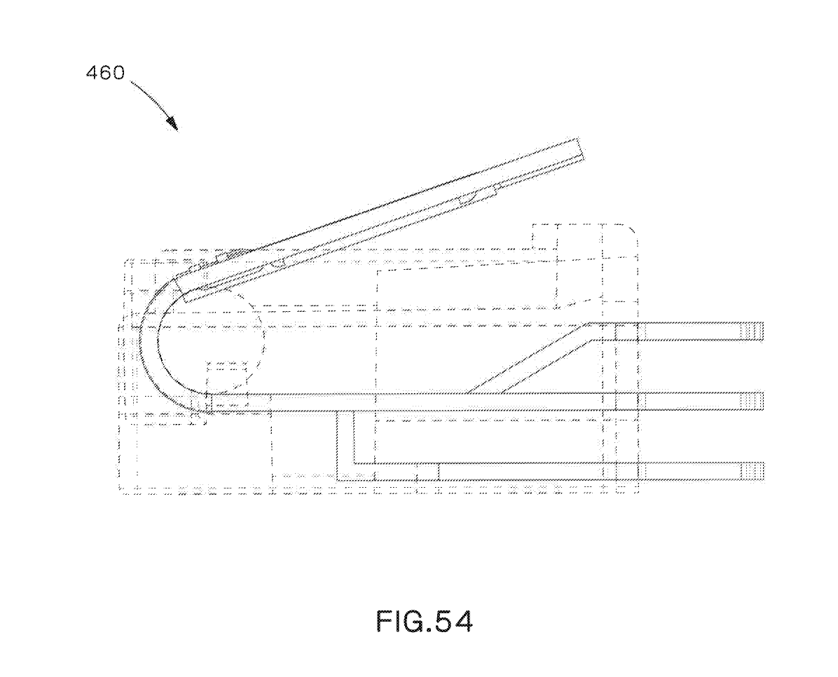

FIG. 54 illustrates sled assembly 460 in side view.

Insulator 466 can be a nonconductive label applied with adhesive and/or heat or other insulating coatings including but not limited to polymer and conformal coatings.

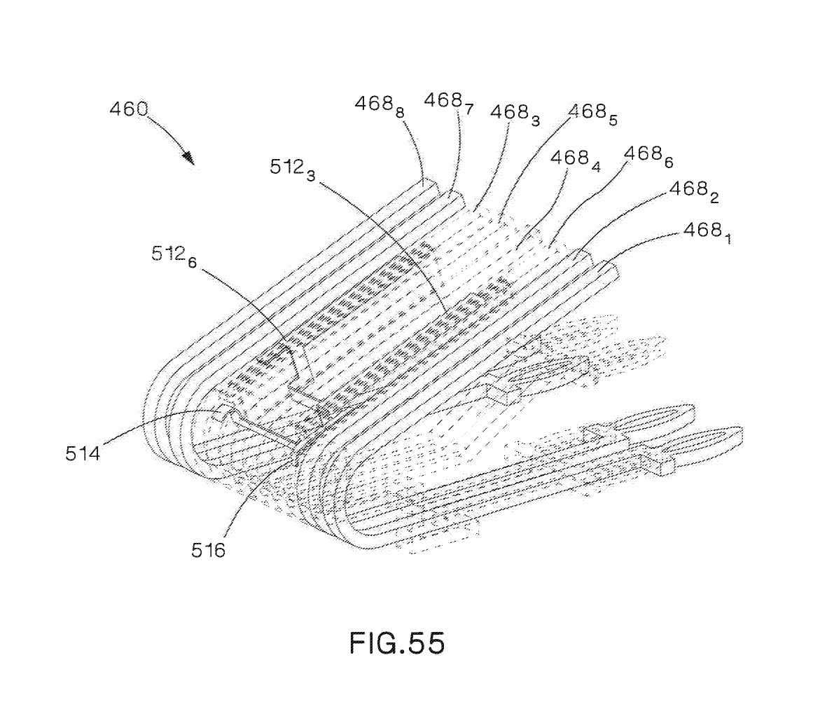

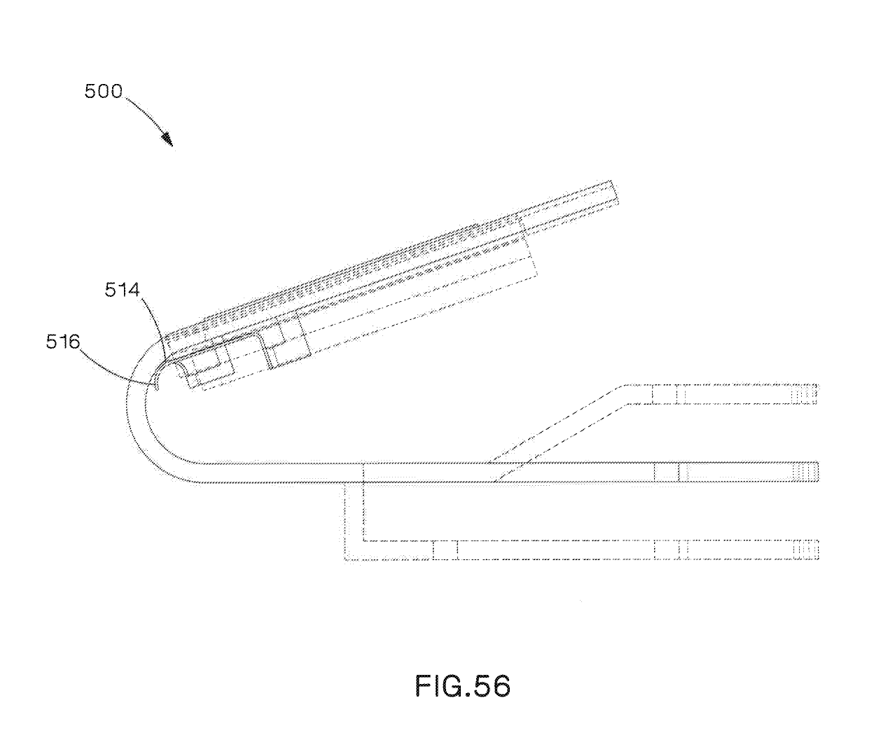

In a second embodiment of the present invention, an alternate sled assembly 500 (shown in FIGS. 55 and 56) PIC covers 512₃ and 512₆ extend under PICS 468₄ and 468₅ to be electrically connected on bottom face of the PIC 468₃ and 468₆, respectively. PIC cover 512₃ is connected at location 514 and PIC cover 512₆ is connected at 516.

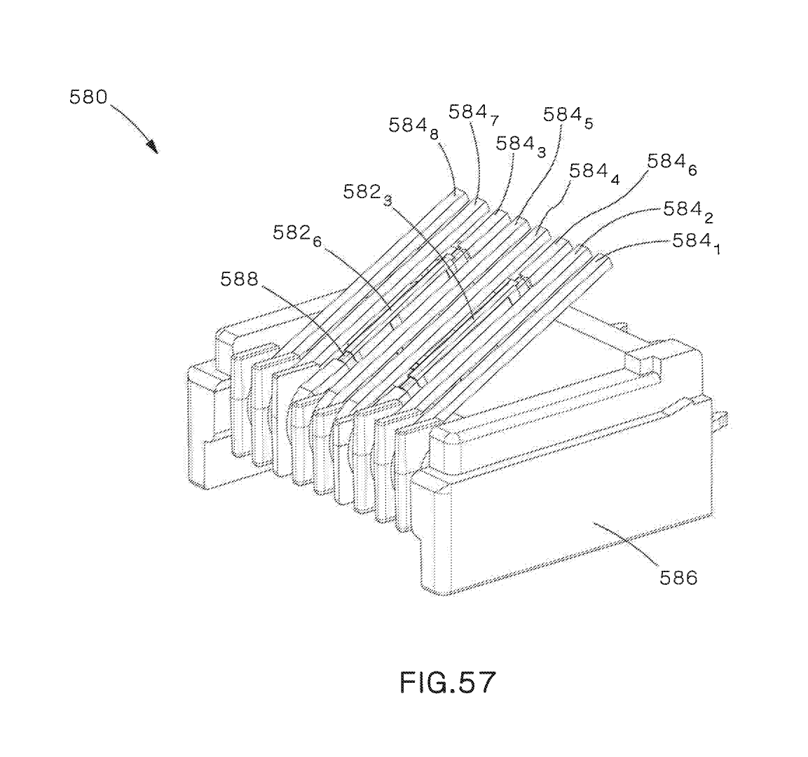

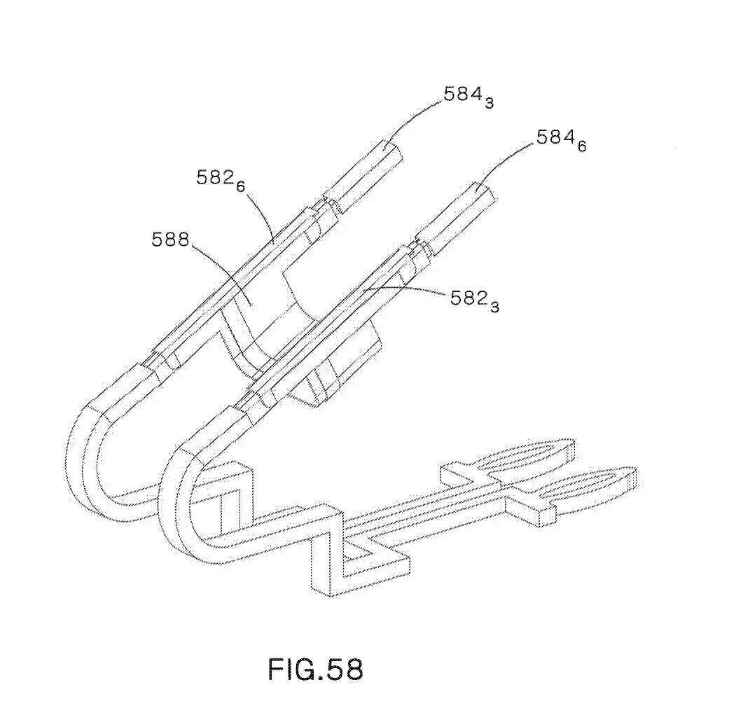

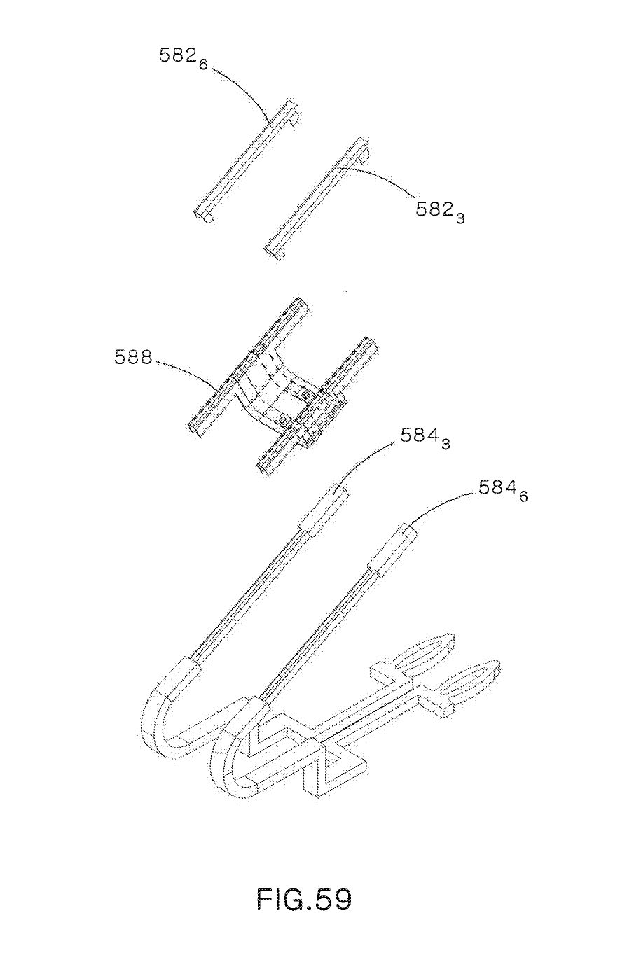

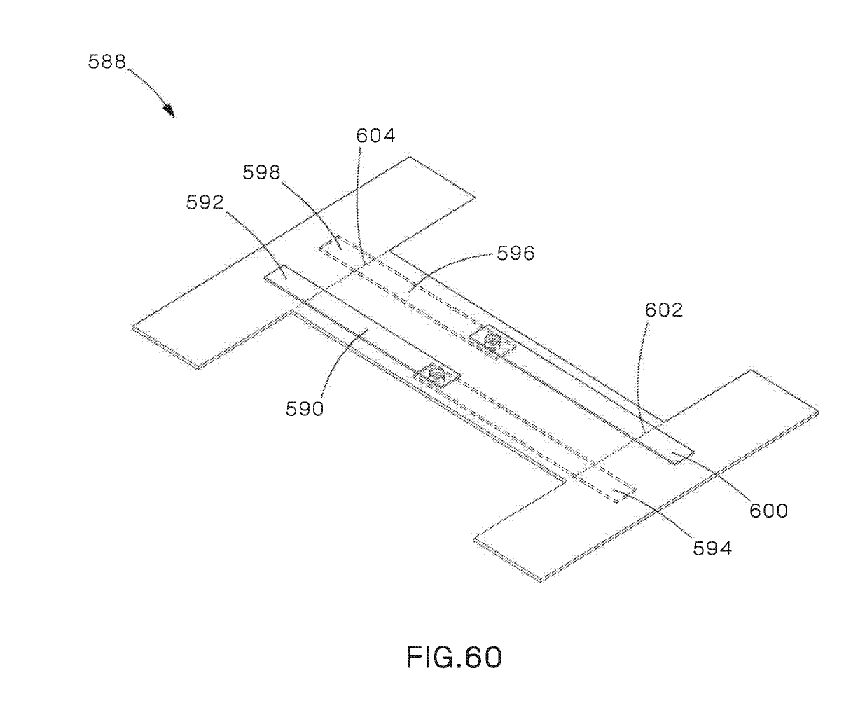

In a third embodiment of the present invention, an alternate sled assembly 580 (shown in FIGS. 57 to 60) contains PIC covers 582₃ and 582₆ that are electrically isolated from supporting PICs 518₄ by flexible PCB 588. Flexible PCB trace 590 (FIG. 60) connects PIC cover 582₆ to PIC 584₆ electrically at contact points 592 and 594 respectively. Flexible PCB trace 596 connects PIC cover 582₃ to PIC 584₃ electrically at contact points 600 and 598 respectively. Traces 590 and 596 are covered with insulating cover lay between lines 602 and 604. Flexible PCB allows PIC cover and PIC connection path to be brought closer to the plug/jack mating interface.

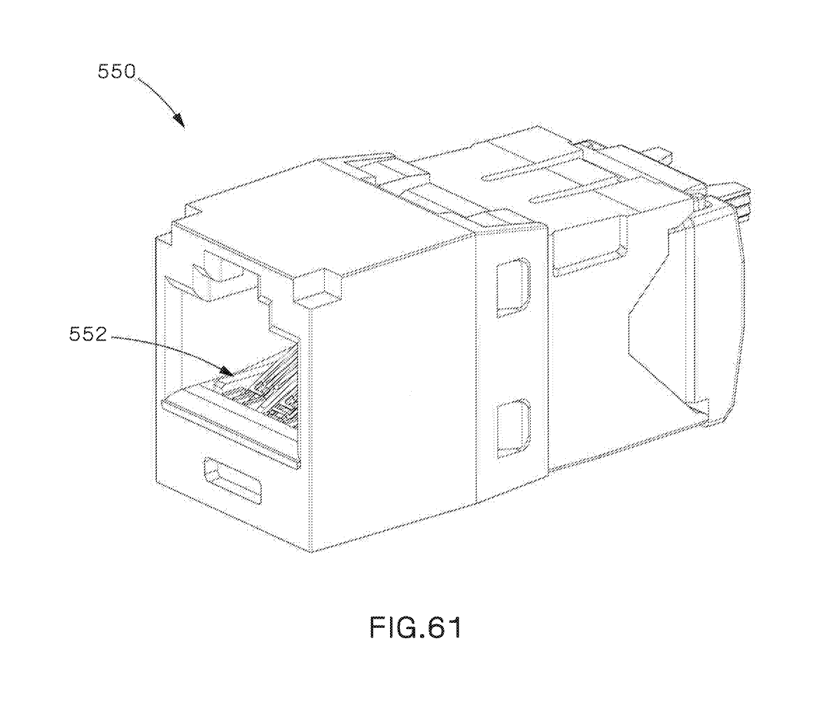

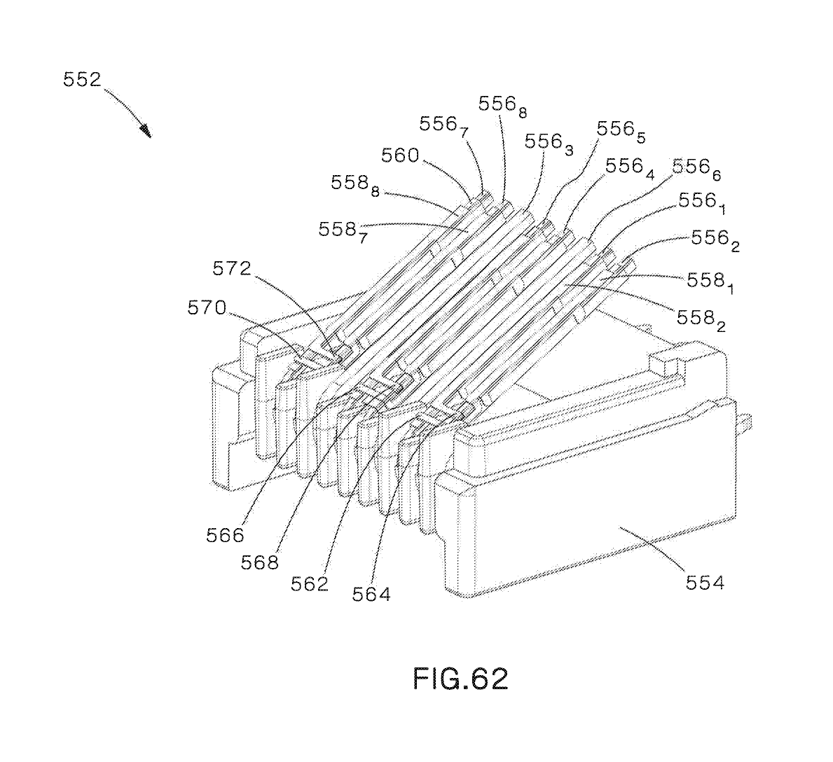

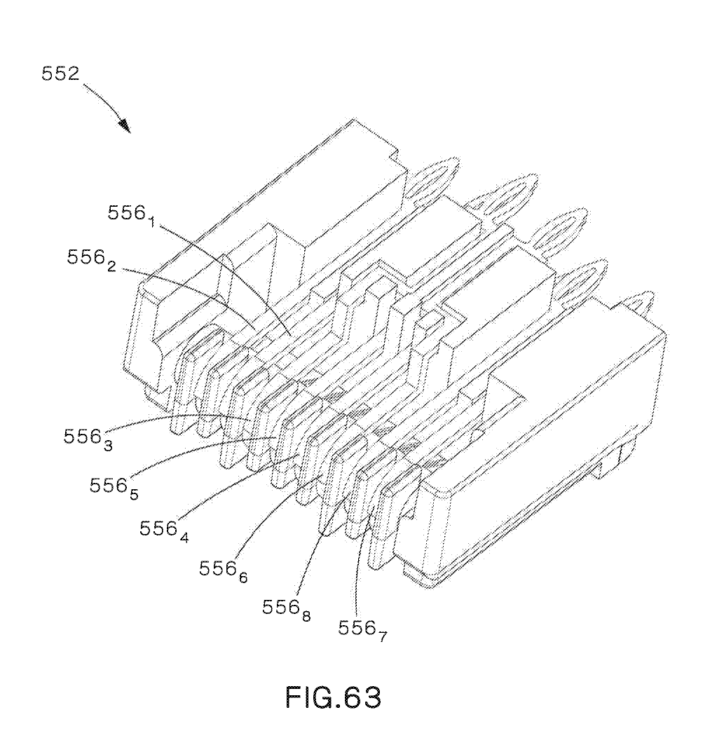

In a fourth embodiment (shown in FIGS. 61 to 63) jack 550 includes sled assembly 552 with sled 554, PICs 556, PIC covers 558 and insulator 560. In this embodiment PIC covers 558 interface plug contacts at positions 1, 2, 4, 5, 7 and 8. PIC covers 558₁, 158₂, 558₄, 558₅, 558₇, 558₈ are mechanically supported but electrically isolated from PICs 556₂, 556₁, 556₅, 556₄, 556₈ and 556₇ respectively to provide spring force. PIC cover 558₁ connects to PIC 556₁ at 562, PIC cover 558₂ connects to PIC 556₂ at 564, PIC cover 558₄ connects to PIC 556₄ at 566, PIC cover 558₅ connects to PIC 556₅ at 568, PIC cover 558₇ connects to PIC 556₇ at 570, PIC cover 558₈ connects to PIC 556₈ at 572. PICs 556₃ and 556₆ position relative to 556₁, 556₄, 556₅ and 556₇ provide compensating coupling 1-3, 3-5, 4-6 and 6-8 while reducing PIC crosstalk coupling 2-3, 3-4, 5-6 and 6-7.

While particular embodiments and applications of the present invention have been illustrated and described, it is to be understood that the invention is not limited to the precise construction and compositions disclosed herein and that various modifications, changes, and variations may be apparent from the foregoing without departing from the spirit and scope of the invention as described.

1. A communication jack configured to receive a plug to form a communication connection, comprising:
a plurality of jack contacts, the plurality of jack contacts at least partially disposed within a plug receiving cavity in the jack;
a structure attached to at least one of the plurality of jack contacts, the structure connected to the at least one jack contact such as to allow the current to flow generally orthogonal the jack contact,

2. The communication jack of claim 1 wherein the structure is attached to the at least one contact proximate to the plug/jack interface.

3. The communication jack of claim 2 wherein the structure is a flexible printed circuit board connected to the jack contact.

4. The communication jack of claim 2 wherein the structure is a plug interface contact (PIC) cover.
